(19) United States
(12) Patent Application Publication
(10) Pub. No.: US 2026/0274676 A1
(43) Pub. Date: Sep. 17, 2026

(54) GRAPHITE AGGLOMERATE PARTICLES, METHOD OF PRODUCTION THEREOF, AND THEIR USE IN ELECTROCHEMICAL CELLS

(71) Applicant: NOUVEAU MONDE GRAPHITE INC., Saint-Michel-des-Saints (CA)

(72) Inventors: Lionel ROUE, Sainte-Julie, Québec (CA); Juan Carlos ABREGO MARTINEZ, Saint-Constant, Québec (CA); Youling WANG, Saint-Constant, Québec (CA); Martin BRASSARD, Saint-Michel-des-Saints, Québec (CA); Philippe RIECKMANN, Saint-Michel-des-Saints, Québec (CA); Elaheh OLIAII, Saint-Michel-des-Saints, Québec (CA); Eric DESAULNIERS, Saint-Michel-des-Saints, Québec (CA)

(21) Appl. No.: 19/166,668

(22) PCT Filed: Mar. 22, 2024
(86) PCT No.: PCT/CA2024/050356

§ 371 Date: Sep. 18, 2025

Related U.S. Application Data
(60) Provisional application No. 63/491,614, filed on Mar. 22, 2023.

(51) Int. Cl. C01B 32/21; H01M 4/36; H01M 4/583

(52) U.S. Cl. CPC C01B 32/21; H01M 4/366; H01M 4/583; C01P 2002/72; C01P 2004/03; C01P 2004/50; C01P 2004/51; C01P 2004/61; C01P 2004/84; C01P 2006/40

(57) ABSTRACT

A method for producing graphite agglomerate particles is provided, the method comprises i) providing a graphite fines slurry; ii) spray drying the graphite fines slurry to form spray-dried re-agglomerated graphite particles; and iii) heat treating the spray-dried re-agglomerated graphite particles to obtain the graphite agglomerate particles, wherein the graphite fines slurry comprises a binder, graphite fines, and a solvent. Graphite agglomerate particles obtained using said method as well as their uses in electrode materials, electrodes, electrochemical cells, and electrochemical accumulators are also described.

### RELATED APPLICATION

This application claims priority under applicable laws to U.S. provisional application No. 63/491,614 filed on Mar. 22, 2023, the content of which is incorporated herein by reference in its entirety for all purposes.

### TECHNICAL FIELD

The present invention generally relates to graphite agglomerate particles, their method of production, and their use in electrochemical cells.

### BACKGROUND

Graphite (either natural or synthetic) has been used as a host structure for Li intercalation at the anode side since the commercialization of the first lithium-ion batteries (LIB) due to its abundance, relatively low cost, high energy and power densities, and long cycle life. It has an operating voltage close to that of Li/Li⁺ (≈0.1 V vs. Li/Li⁺) and a theoretical capacity of 372 mAh·g⁻¹ in its fully lithiated state, which corresponds to the insertion of one Li per six carbon atoms (LiC₆). Despite the ongoing efforts to improve the performance of LIB anodes using high-capacity materials such as silicon or silicon oxide, graphite is still the anode of choice in the current state-of-the-art LIBs, with a dominant market share of 98%. As of 2020, synthetic graphite and natural graphite accounted for 58% and 39%, respectively, of the anode market for LIBs.

However, since the production of synthetic graphite is energy-intensive, time consuming, and has a large environmental footprint, the demand for natural graphite is expected to grow and take over the graphite market by 2030. Natural graphite is further classified into three types: lump graphite, amorphous graphite, and flake graphite, the latter being desirable for LIBs due to their high crystallinity, carbon content (80-95%) and good electric conductivity.

After mining and separation from graphite ore, raw graphite flakes require further processing to make the material suitable for use in LIBs. One of the crucial steps is called spheroidization, in which the graphite flakes are mechanically shaped via sophisticated milling techniques into nearly spherical particles (typically D50=10-25 μm) to decrease their surface area and to increase the material density. Moreover, the rounded particles offer easier processability during electrode manufacture compared to flakes. However, due to the use of complex classifier mill cascades required to obtain particles suitable for LIBs anodes, which can consist of up to 30 classifier mills, conventional spheroidization processes can be lengthy and energy intensive, and results in low yields of about 30-50%, meaning significant losses of graphite in the process. The by-product mainly consists of fine graphite flakes whose particle size is too fine (<10 μm) for the manufacture of LIBs anodes, as it is known that fine particles with large surface area lead to larger solid electrolyte interphase (SEI) layers and higher irreversible capacity.

Accordingly, many technical challenges still exist and there is a need for the development of new methods to recycle and valorize graphite fines.

### SUMMARY

According to some aspects, embodiments of the technology as described herein include the following items:

1. A method for producing graphite agglomerate particles, the method comprising the steps of:
i) providing a graphite fines slurry comprising a plurality of graphite fines, a solvent, and a binder;
ii) spray drying the graphite fines slurry to for spray-dried re-agglomerated graphite particles; and
iii) heat treating the spray-dried re-agglomerated graphite particles to obtain the graphite agglomerate particles.

2. The method of item 1, wherein the binder is a polymer binder.

3. The method of item 1, wherein the polymer binder is selected from the group consisting of carboxymethyl cellulose (CMC) polyvinyl alcohol (PVA), polyethylene glycol (PEG), polyacrylic acid (PAA), polyvinylpyrrolidone (PVP), polylactic acid (PLA), cellulose, chitin, starch, polycaprolactone (PCL), polyhydroxy butyrate (PHB), and a combination of at least two thereof.

4. The method of item 3, wherein the polymer binder is carboxymethyl cellulose (CMC).

5. The method of any one of items 1 to 4, wherein the solvent is selected from the group consisting of water, methanol, acetone, ethanol, dichloromethane, tetrahydrofuran, ethyl acetate, chloroform, glycerin, dimethylformamide, dimethyl sulfoxide, and a miscible combination of at least two thereof.

6. The method of item 5, wherein the solvent is water.

7. The method of any one of items 1 to 6, wherein a mass ratio of graphite fines to the binder in the graphite fines slurry is between about 4:1 and about 20:1, upper and lower limits included.

8. The method of item 8, wherein the mass ratio of graphite fines to the binder in the graphite fines slurry is at least about 4:1, or at least about 5:1, or at least about 6:1, or at least about 7:1.

9. The method of item 7 or 8, wherein the mass ratio of graphite fines to the binder in the graphite fines slurry is at most about 20:1, or at most about 15:1, or at most about 10:1, or at most about 8:1.

10. The method of any one of items 7 to 9, wherein the mass ratio of graphite fines to the binder in the graphite fines slurry is about 6:1.

11. The method of any one of items 1 to 10, wherein the graphite fines slurry comprises between about 14 wt. % and about 35 wt. % of graphite fines, upper and lower limits included.

12. The method of item 11, wherein the graphite fines slurry comprises at least about 14 wt. %, or at least about 18 wt. %, or at least about 21 wt. %, or at least about 24 wt. % of graphite fines.

13. The method of item 11 or 12, wherein the graphite fines slurry comprises at most about 35 wt. %, or at most about 33 wt. %, or at most about 30 wt. %, or at most about 28 wt. % of graphite fines.

14. The method of any one of items 11 to 13, wherein the graphite fines slurry comprises about 24 wt. % of graphite fines.

15. The method of any one of items 1 to 14, wherein the graphite fines in the graphite fines slurry have been purified.

16. The method of any one of items 1 to 15, wherein the purity of the graphite fines is between about 99.70% and about 99.99%, upper and lower limits included.

17. The method of item 16, wherein the purity of the graphite fines is at least about 99.70%, or at least about 99.8%, or at least about 99.90%, or at least about 99.95%.

18. The method of item 16 or 17, wherein the purity of the graphite fines is at most about 99.99%, or at most about 99.95%.

19. The method of any one of items 16 to 18, wherein the purity of the graphite fines is about 99.95%.

20. The method of any one of items 1 to 19, wherein the D₅₀ of graphite fines is between about 3 μm and about 10 μm, upper and lower limits included.

21. The method of item 20, wherein the D₅₀ of the graphite fines is at least about 3 μm, or at least about 4 μm, or at least about 5 μm, or at least about 6 μm.

22. The method of item 20 or 21, wherein the D₅₀ of the graphite fines is at most about 10 μm, or at most about 9 μm, or at most about 8 μm, or at most about 7 μm.

23. The method of any one of items 20 to 22, wherein the D₅₀ of the graphite fines is about 7 μm.

24. The method of any one of items 1 to 23, wherein the graphite fines slurry comprises between about 0.7 wt. % and about 6.0 wt. % of the binder, upper and lower limits included.

25. The method of item 24, wherein the graphite fines slurry comprises at least about 0.7 wt. %, or at least about 1.4 wt. %, or at least about 2.5 wt. %, or at least about 3.0 wt. % of the binder.

26. The method of item 24 or 25, wherein the graphite fines slurry comprises at most about 6.0 wt. %, or at most about 5.0 wt. %, or at most about 4.5 wt. %, or at most about 4.0 wt. % of the binder.

27. The method of any one of items 24 to 26, wherein the graphite fines slurry comprises about 4.0 wt. % of the binder.

28. The method of any one of items 1 to 27, wherein the graphite fines slurry further comprises a cross-linking agent.

29. The method of item 28, wherein the cross-linking agent is an organic cross-linking agent or an inorganic cross-linking agent.

30. The method of item 29, wherein the cross-linking agent is an organic cross-linking agent.

31. The method of any one of items 28 to 30, wherein the cross-linking agent is selected from the group consisting of citric acid, formic acid, acetic acid, oxalic acid, and a combination of at least two thereof.

32. The method of item 31, wherein the cross-linking agent is citric acid.

33. The method of any one of items 28 to 32, wherein the graphite fines slurry comprises between about 0.5 wt. % and about 4.0 wt. % of the cross-linking agent, upper and lower limits included.

34. The method of item 33, wherein the graphite fines slurry comprises at least about 0.5 wt. %, or at least about 1.0 wt. %, or at least about 1.5 wt. %, or at least about 2.0 wt. % of the cross-linking agent.

35. The method of item 32 or 34, wherein the graphite fines slurry comprises at most about 4 wt. %, or at most about 3.5 wt. %, or at most about 3.0 wt. %, or at most about 2.5 wt. % of cross-linking agent.

36. The method of any one of items 32 to 35, wherein the graphite fines slurry comprises about 3.0 wt. % of the cross-linking agent.

37. The method of any one of items 1 to 36, wherein the graphite fines slurry comprises between about 58 wt. % and about 83 wt. % of the solvent, upper and lower limits included.

38. The method of item 37, wherein the graphite fines slurry comprises at least about 53 wt. %, or at least about 58 wt. %, or at least about 62 wt. %, or at least about 66 wt. %; and/or at most about 83 w/w %; at most about 80 w/w %; at most about 72 w/w %; or at most about 69 w/w % of the solvent.

39. The method of item 37 or 38, wherein the graphite fines slurry comprises at most about 83 wt. %, or at most about 80 wt. %, or at most about 72 wt. %, or at most about 69 wt. % of the solvent.

40. The method of any one of items 37 to 39, wherein the graphite fines slurry comprises about 69 wt. % of the solvent.

41. The method of any one of items 28 to 40, wherein the graphite fines slurry comprises about 24 wt. % of graphite fines, about 4.0 wt. % of the binder, about 3.0 wt. % of the cross-linking agent, and about 69 wt. % of the solvent.

42. The method of any one of items 1 to 41, wherein providing the graphite fines slurry comprises preparing the graphite fines slurry.

43. The method of item 42, wherein the graphite fines slurry is prepared by combining the graphite fines, the binder, optionally the cross-linking agent, and the solvent, and then mixing the components together.

44. The method of item 43, wherein the graphite fines slurry is mixed by resonant acoustic mixer.

45. The method of item 44, wherein the graphite fines slurry is mixed at an acceleration of 50 G for about 30 minutes.

46. The method of any one of items 1 to 45, wherein the graphite fines slurry further comprises silicon particles.

47. The method of item 46, wherein the D₅₀ of the silicon particles in the graphite fines slurry is between about 50 nm and about 5 μm, upper and lower limits included.

48. The method of item 46 or 47, wherein the content of silicon particles in the graphite fines slurry is between about 0.42 wt. % and about 11.55 wt. %, upper and lower limits included.

49. The method of any one of items 1 to 48, wherein the graphite fines slurry further comprises an additive selected from carbon black, graphite, graphene, carbon fibers, carbon nanotubes, and a combination of at least two thereof.

50. The method of item 49, wherein the additive is carbon nanotubes.

51. The method of item 50, wherein the carbon nanotubes are single-walled carbon nanotubes, multi-walled carbon nanotubes, or a combination thereof.

52. The method of any one of items 49 to 51, wherein the graphite fines slurry comprises between about 0.1 wt. % and about 3 wt. % of carbon nanotubes, upper and lower limits included.

53. The method of any one of items 1 to 52, wherein a feed rate of the spray drying is between about 10 mL·min⁻¹ and about 22 mL·min⁻¹, upper and lower limits included.

54. The method of item 53, wherein the feed rate of the spray drying is at least about 10 mL·min⁻¹, or at least about 12 mL·min⁻¹, or at least about 14 mL·min⁻¹, or at least about 16 mL·min⁻¹.

55. The method of item 53 or 54, wherein the feed rate of the spray drying is at most about 22 mL·min⁻¹, or at most about 21 mL·min⁻¹, or at most about 20 mL·min⁻¹, or at most about 18 mL·min⁻¹.

56. The method of any one of items 53 to 55, wherein the feed rate of the spray drying is about 20.3 mL·min⁻¹.

57. The method of any one of items 1 to 56, wherein the inlet temperature during the spray drying step is between about 190° C. and about 220° C., upper and lower limits included.

58. The method of item 57, wherein the inlet temperature during the spray drying step is at least about 190° C., or at least about 200° C.

59. The method of item 57 or 58, wherein the inlet temperature during the spray drying step is at most about 220° C., or at most about 210° C.

60. The method of any one of items 57 to 59, wherein an inlet temperature during the spray drying step is about 210° C.

61. The method of any one of items 1 to 60, wherein an air blow rate during the spray drying step is between about 2.0 m³·min⁻¹ and about 2.5 m³·min⁻¹, upper and lower limits included.

62. The method of any one of items 1 to 61, wherein the spray-dried re-agglomerated graphite particles are heat treated in the presence of a carbon precursor to obtain carbon-coated graphite agglomerate particles.

63. The method of item 62, wherein the carbon precursor is selected from petroleum pitch, coal tar pitch, biomass pitch, a combination of at least two thereof, and any similar material.

64. The method of item 63, wherein the carbon precursor is coal tar pitch.

65. The method of any one of items 1 to 64, wherein the heat treatment step comprises heating the spray-dried re-agglomerated graphite particles at a temperature between about 550° C. and about 1300° C., upper and lower limits included.

66. The method of item 65, wherein the spray-dried re-agglomerated graphite particles are heated at a temperature of at least about 550° C., or at least about 600° C., or at least about 700° C., or at least about 750° C.

67. The method of item 65 or 66, wherein the spray-dried re-agglomerated graphite particles are heated at a temperature of at most about 1300° C., or at most about 1100° C., at most about 1000° C., or at most about 900° C.

68. The method of any one of items 65 to 67, wherein the spray-dried re-agglomerated graphite particles are heated at a temperature of about 1000° C.

69. The method of any one of items 1 to 68, wherein the spray-dried re-agglomerated graphite particles formed in step (ii) are mixed with a carbon precursor followed by a heat treatment step for the thermal decomposition of the carbon precursor.

70. The method of item 69, wherein the carbon precursor is coal tar pitch.

71. The method of item 69 or 70, wherein the spray-dried re-agglomerated graphite particles:carbon precursor mass ratio is about 9:1.

72. The method of any one of items 69 to 71, wherein the mixing step is performed by resonant acoustic mixer.

73. The method of item 72, wherein the mixing step is performed at an acceleration of 50 G for about 15 minutes.

74. The method of any one of items 69 to 73, wherein the spray-dried re-agglomerated graphite particles and the carbon precursor are mixed together using wet mixing or dry mixing.

75. The method of any one of items 69 to 74, wherein the amount of carbon precursor in a mixture comprising the spray-dried re-agglomerated graphite particles and the carbon precursor is between about 5 wt. % and about 30 wt. %, upper and lower limits included.

76. The method of item 75, wherein the amount of carbon precursor in the mixture is at least about 5 wt. %, or at least about 10 wt. %, or at least about 15 wt. %.

77. The method of item 75 or 76, wherein the amount of carbon precursor in the mixture is at most about 30 wt. %, or at most about 25 wt. %, or at most about 20 wt. %.

78. The method of any one of items 75 to 77, wherein the amount of carbon precursor in the mixture is about 10 wt. %.

79. The method of any one of items 69 to 78, wherein the thermal decomposition of the carbon precursor and of the binder are performed in a single step heat treatment.

80. The method of item 79, wherein the heat treatment is performed as two sub-steps, wherein spray-dried re-agglomerated graphite particles are first heat treated to form graphite agglomerate particles, and then said graphite agglomerate particles are mixed with the carbon precursor, followed by a second heat treatment for carbon coating.

81. The method of any one of items 1 to 80, wherein the heat treatment further comprises subjecting the spray-dried re-agglomerated graphite particles to a high temperature heat treatment performed at a temperature between about 2000° C. and about 3000° C., upper and lower limits included.

82. Graphite agglomerate particles produced using the method as defined in any one of items 1 to 81.

83. The graphite agglomerate particles of item 82, wherein said graphite agglomerate particles are spherical-shaped particles or near-spherical-shaped particles.

84. The graphite agglomerate particles of item 82 or 83, wherein the D₅₀ of said graphite agglomerate particles is between about 18 μm and about 21 μm, upper and lower limits included.

85. The graphite agglomerate particles of item 82 or 83, wherein the D₅₀ of said graphite agglomerate particles is between about 20 μm and about 24 μm, upper and lower limits included.

86. The graphite agglomerate particles of item 82 or 83, wherein the D₅₀ of said graphite agglomerate particles is between about 13 μm and about 17 μm, upper and lower limits included.

87. The graphite agglomerate particles of any one of items 82 to 86, wherein said graphite agglomerate particles are carbon-coated graphite agglomerate particles.

88. The graphite agglomerate particles of any one of items 82 to 87, wherein said graphite agglomerate particles are pitch-coated graphite agglomerate particles.

89. The graphite agglomerate particles of any one of items 82 to 88, further comprising silicon.

90. The graphite agglomerate particles of item 89, wherein said graphite agglomerate particles comprise a silicon content of greater than 0 wt. %.

91. The graphite agglomerate particles of item 90, wherein said graphite agglomerate particles comprise a silicon content of at least about 3 wt. %.

92. The graphite agglomerate particles of item 90 or 91, wherein said graphite agglomerate particles comprise a silicon content of at most about 50 wt. %, or at most about 33 wt. %.

93. An electrode material comprising graphite agglomerate particles as defined in any one of items 82 to 92.

94. The electrode material of item 93, further comprising an electronically conductive material.

95. The electrode material of item 94, wherein the electronically conductive material is selected from carbon black, graphite, graphene, carbon fibers, carbon nanotubes, and a combination of at least two thereof.

96. The electrode material of item 95, wherein the electronically conductive material is carbon black, carbon nanotubes, or a combination thereof.

97. The electrode material of item 96, wherein the carbon nanotubes are single-walled carbon nanotubes, multi-walled carbon nanotubes, or a combination thereof.

98. The electrode material of any one of items 93 to 97, further comprising at least one additive.

99. The electrode material of any one of items 93 to 98, further comprising at least one binder.

100. The electrode material of item 99, wherein the binder is selected from a polymer binder of the polyether type, a polymer binder of the polycarbonate type, a polymer binder of the polyester type, a fluorinated polymer, and a water-soluble binder.

101. An electrode comprising the electrode material as defined in any one of items 93 to 100 applied on a current collector.

102. The electrode of item 101, wherein the current collector is a copper foil.

103. The electrode of item 101 or 102, wherein the electrode is calendered.

104. The electrode of any one of items 101 to 103, wherein the electrode is an anode.

105. An electrochemical cell comprising an anode, a cathode, and an electrolyte, wherein at least one of the anode and the cathode comprise the electrode material as defined in any one of items 93 to 100.

106. An electrochemical cell comprising an anode, a cathode, and an electrolyte, wherein at least one of the anode and the cathode is the electrode as defined in any one of items 101 to 103.

107. An electrochemical accumulator comprising at least one electrochemical cell as defined in item 105 or 106.

108. The electrochemical accumulator of item 107, wherein said electrochemical accumulator is a battery selected from a lithium battery, a lithium-ion battery, a sodium battery, a sodium-ion battery, a magnesium battery, and a magnesium-ion battery.

109. The electrochemical accumulator of item 107 or 108, wherein said electrochemical accumulator is a lithium-ion battery.

110. A method for producing graphene agglomerate particles comprising the steps of:
i) providing a graphene fines slurry comprising a plurality of graphene fines, a solvent, and a polymer binder;
ii) spray drying the graphene fines slurry to form spray-dried re-agglomerated graphene particles; and
iii) heat treating the spray-dried re-agglomerated graphene particles to obtain the graphene agglomerate particles.

### BRIEF DESCRIPTION OF THE DRAWINGS

FIG. 1 is a flow diagram of a method for producing graphite agglomerate particles according to one embodiment.

FIG. 2 is a schematic representation of a spray drying step according to an embodiment of the method as defined herein.

FIG. 3 shows scanning electron microscopy (SEM) images in a) of the raw material (graphite fines), and in b) of the graphite agglomerate particles obtained by an embodiment of the method as defined herein.

FIG. 4 shows in a) particle size distribution (PSD) curves, and in b) X-ray diffraction (XRD) patterns obtained for fine natural graphite (f-NG) raw graphite, spray-dried re-agglomerated graphite particles obtained by spray drying according to a step of an embodiment of the method as defined herein, pitch-coated graphite agglomerate particles obtained through 1-step HT after spray drying according to an embodiment of the method as defined herein, and PGPT102 commercial graphite.

FIG. 5 shows SEM images in a) of f-NG raw material, in b) of agglomerated graphite particles obtained by spray drying followed by heat treatment, in c) of a single agglomerated graphite particle and detail of its surface, in d) of a cross-section of an agglomerated graphite particle, in e) of pitch-coated graphite agglomerate particles and surface details, and in f) of a cross-section of a pitch-coated graphite agglomerate particle.

FIG. 6 shows top and cross-section SEM images of electrodes comprising a) non-calendered graphite agglomerate particles, b) non-calendered pitch-coated graphite agglomerate particles, c) calendered graphite agglomerate particles, and d) calendered pitch-coated graphite agglomerate particles, as well as FIB-SEM images of e) non-calendered, and f) calendered graphite agglomerate electrodes.

FIG. 7 shows in a) the first charge-discharge cycle of various electrodes, in b) differential capacity curves of various electrodes, in c) the specific discharge capacity and Coulombic efficiency of various electrodes, d) the capacity retention of a graphite agglomerate-based electrode and of a conventional PGPT102 electrode throughout 200 cycles, in e) charge-discharge cycles of various electrodes, and in f) differential capacity curves of a graphite agglomerate-based electrode and a conventional PGPT102 electrode at selected cycles.

FIG. 8 shows a comparison of cumulative irreversible capacity of graphite agglomerate-based electrodes and of a conventional PGPT102 electrode.

FIG. 9 shows SEM images in a) of a graphite agglomerate electrode before cycling, in b) of a pitch-coated graphite agglomerate particles (1-step HT) electrode before cycling, and in c) of a pitch-coated graphite agglomerate particles (2-step HT) electrode before cycling; (a′, b′, and c′) show the corresponding electrodes after 200 cycles; and (a″, b″, and c″) show corresponding cross-section images of said cycled electrodes.

FIG. 10 shows SEM images of graphite agglomerate particles obtained by the method as defined herein with an f-NG content in a) of 14 wt. %, in b) of 21 wt. %, in c) of 28 wt. %, and in d) of 33 wt. %.

FIG. 11 shows SEM images of graphite agglomerate particles obtained by the method as defined herein with a f-NG:CMC mass ratio in a) on 50:1, in b) of 30:1, in c) of 10:1, and in d) of 6:1.

FIG. 12 shows SEM images of graphite agglomerate particles obtained by the method as defined herein with a feed rate in a) of 9.8 mL/min, in b) of 14.7 mL/min, and in c) of 20.3 mL/min.

FIG. 13 shows SEM images of graphite agglomerate particles obtained by the method as defined herein with an inlet temperature in a) of 200° C., in b) of 210° C., and in c) of 220° C.

FIG. 14 shows SEM images of graphite agglomerate particles obtained by the method as defined herein with an air blow rate in a) of 2.5 m³/min; and in b) of 2.0 m³/min.

FIG. 15 is a weighted Pareto chart used to determine the effect of the slurry composition and spray drying parameters on the D₅₀ of the resulting agglomerated graphite particles as defined herein.

FIG. 16 shows graphs showing the PSD before (dotted line) and after (dashed line) a ball milling step obtained for agglomerated graphite particles in (a) without and in (b) with 3 wt. % of citric acid as cross-linking agent.

FIG. 17 shows a PSD comparison between pitch-coated graphite agglomerate particles obtained through 1-step HT and 2-step HT according to teachings disclosed herein.

FIG. 18 shows an XRD pattern comparison of pitch-coated graphite agglomerate particles obtained through 1-step HT and 2-step HT according to teachings disclosed herein.

FIG. 19 shows a deconvolution of (101) peaks for various graphite materials to calculate the [A_{3R(101)}/A_{2H(101)}] mass ratio.

FIG. 20 shows in a) a SEM image of a PGPT 102 commercial graphite before spray drying and heat treatment, in b) a SEM image of a PGPT 102 commercial graphite after spray drying and heat treatment, and in c) a high magnification image of the graphite surface showing the nano-grains formed due to the carbonization of the binder.

FIG. 21 shows an SEM image of pitch-coated graphite agglomerate particles obtained through the 2-step HT according to teachings disclosed herein.

FIG. 22 shows specific discharge capacity and Coulombic efficiency with cycling of non-calendered (open symbols) and calendered (solid symbols) electrodes in a) for a conventional PGPT102, in b) for uncoated graphite agglomerate particles, and in c) for pitch-coated graphite agglomerate particles.

FIG. 23 shows differential capacity curves comparing the 1^{st} and the 5^{th} cycle of various electrodes in the 0.5 V to 0.9 V potential range to show the cathodic peak ascribed to the formation of the SEI layer in the 1^{st} discharge.

FIG. 24 shows charge (delithiation) rate capability tests of electrodes comprising f-NG, graphite agglomerate particles, and conventional PGPT102. The discharge rate was fixed at C/10, all the electrodes were calendered, and their graphite mass loading was 5 mg·cm⁻².

FIG. 25 shows a modular view of a control station for controlling steps of the method described herein.

FIG. 26 shows SEM images of a graphite agglomerate particle with carbon nanotubes (CNTs) obtained by the method as defined herein.

FIG. 27 shows cross-sectional SEM images of a graphite agglomerate particle with CNTs obtained by the method as defined herein.

FIG. 28 shows SEM images in a) of uncoated graphite agglomerate particles with CNTs, and in b) of pitch-coated graphite agglomerate particles with CNTs.

FIG. 29 is a graph showing the PSD for conventional PGPT102, graphite agglomerate particles, pitch-coated graphite agglomerate particles, graphite agglomerate particles with CNTs, and pitch-coated graphite agglomerate particles with CNTs.

FIG. 30 shows a graph of the discharge specific capacity (mAh·g⁻¹) as a function of the cycle number. Results are shown for conventional PGPT102, graphite agglomerate particles, pitch-coated graphite agglomerate particles, graphite agglomerate particles with CNTs, and pitch-coated graphite agglomerate particles with CNTs.

FIG. 31 shows a graph of the delithiation rate capability performances. Results are shown for conventional PGPT102, graphite agglomerate particles, pitch-coated graphite agglomerate particles, graphite agglomerate particles with CNTs, and pitch-coated graphite agglomerate particles with CNTs.

FIG. 32 shows SEM images in a) of raw graphite fines, in b) of micro silicon powder, in c) of nano-silicon powder, in d) of a graphite agglomerate particle, in e) of a graphite silicon composite agglomerate particle (9 wt. % micro silicon), and in f) of a graphite silicon composite agglomerate particle (9 wt. % nano-silicon).

FIG. 33 shows in a) XRD patterns, and in b) a graph showing the PSD for raw graphite fines, micro silicon powder, nano-silicon powder, graphite agglomerate particles, graphite silicon composite agglomerate particles (9 wt. % micro silicon), and graphite silicon composite agglomerate particles (9 wt. % nano silicon).

FIG. 34 shows a graph of the discharge specific capacity as a function of the cycle number. Results are shown in a) for graphite agglomerate particles, graphite silicon composite agglomerate particles (9 wt. % nano silicon) obtained by resonant acoustic mixer, graphite silicon composite agglomerate particles (9 wt. % micro silicon) obtained by spray drying, graphite silicon composite agglomerate particles (9 wt. % nano silicon) obtained by spray drying. Results are shown in b) for graphite agglomerate particles, graphite silicon composite agglomerate particles (5 wt. % nano silicon), graphite silicon composite agglomerate particles (9 wt. % nano silicon), and graphite silicon composite agglomerate particles (15 wt. % nano silicon).

FIG. 35 shows in a) a SEM image of graphite silicon composite agglomerate particles with CNTs, and in b) a cross-section of a single graphite silicon composite agglomerate particle with CNTs.

FIG. 36 shows in a) XRD patterns for raw graphite fines, graphite nano-silicon composite agglomerate particles without CNTs, nano-silicon powder, and graphite nano-silicon composite agglomerate particles with CNTs, and in b) a graph showing the PSD for raw graphite fines, graphite nano-silicon composite agglomerate particles without CNTs, and graphite nano-silicon composite agglomerate particles with CNTs.

FIG. 37 shows in a) a graph of the discharge specific capacity as a function of the cycle number, and in b) a graph of the capacity retention as a function of the cycle number for graphite agglomerate particles, graphite nano-silicon composite agglomerate particles without CNTs, and graphite nano-silicon composite agglomerate particles with CNTs.

### DETAILED DESCRIPTION

The following detailed description and examples are illustrative and should not be interpreted as further limiting the scope of the invention. On the contrary, it is intended to cover all alternatives, modifications and equivalents that can be included as defined by the present description. The objects, advantages and other features of the methods will be more apparent and better understood upon reading the following non-restrictive description and references made to the accompanying drawings.

Where applicable, although process flow diagrams can be used to describe embodiments, the invention is not limited to those diagrams or to the corresponding descriptions. Furthermore, for the sake of simplicity and clarity, namely so as to not unduly burden the figures with steps, reactants, equipment and/or products, not all figures contain all the steps, reactants, equipment and/or products. Some steps, reactants and/or products can be found in only one figure, and steps, reactants, equipment and/or products of the present disclosure which are illustrated in other figures can be easily inferred therefrom.

All technical and scientific terms and expressions used herein have the same definitions as those commonly understood by the person skilled in the art when relating to the present technology. The definition of some terms and expressions used herein is nevertheless provided below for clarity purposes.

When the term “about” is used herein, it means “approximately”, “around”, or “in the region of”. When the term “about” is used in relation to a numerical value, it modifies it; for example, by a variation of 5% or 10% above and below its nominal value. This term may also take into account rounding of a number or the probability of random errors in experimental measurements, for instance, due to equipment limitations.

When a range of values is mentioned herein, the lower and upper limits of the range are, unless otherwise indicated, always included in the definition. When a range of values is mentioned in the present application then all intermediate ranges and subranges, as well as individual values included in the ranges, are intended to be included.

It is worth mentioning that throughout the following description when the article “a” is used to introduce an element it does not have the meaning of “only one” it rather means of “one or more”. It is to be understood that where the specification states that a step, component, feature, or characteristic “may”, “might”, “can”, or “could” be included, that particular component, feature or characteristic is not required to be included. The terms “comprising”, “having”, “including”, and “containing” are to be construed as open-ended terms (i.e., meaning “including, but not limited to”) unless otherwise indicated.

The expression “particle size” is described herein by its distribution of particle size dx. Therein, the value dx represents the diameter relative to which x % of the particles have diameters less than dx. For example, the d₁₀ value is the particle size at which 10% of all particles are smaller than that particle size. The d90 value is the particle size at which 90% of all particles are smaller than that particle size. The d₅₀ value is thus the median particle size, i.e. 50% of all particles are bigger and 50% are smaller than that particle size.

When the term “slurry” is used herein, it refers to an “emulsion”, a “solution”, a “suspension”, or a “semiliquid mixture” comprising fine material (fines) in a solvent.

All methods described herein can be performed in any suitable order unless otherwise indicated herein or otherwise clearly contradicted by context.

The use of any and all examples, or exemplary language (e.g., “such as”) provided herein, is intended merely to better illuminate the teachings presented herein and does not pose a limitation on the scope protection unless otherwise claimed.

No language in the specification should be construed as indicating any non-claimed element as essential to the practice of the invention.

Various methods described herein are related to the recycling and revalorisation of by-product graphite fines via agglomeration. For example, the agglomerated graphite produced by the method as described herein can be used as anode material in LIBs.

The present technology relates to graphite agglomerate particles, methods, and systems for their production as well as electrode materials, electrodes, electrochemical cells, and batteries comprising said graphite agglomerate particles.

### Method for Producing Graphite Agglomerate Particles

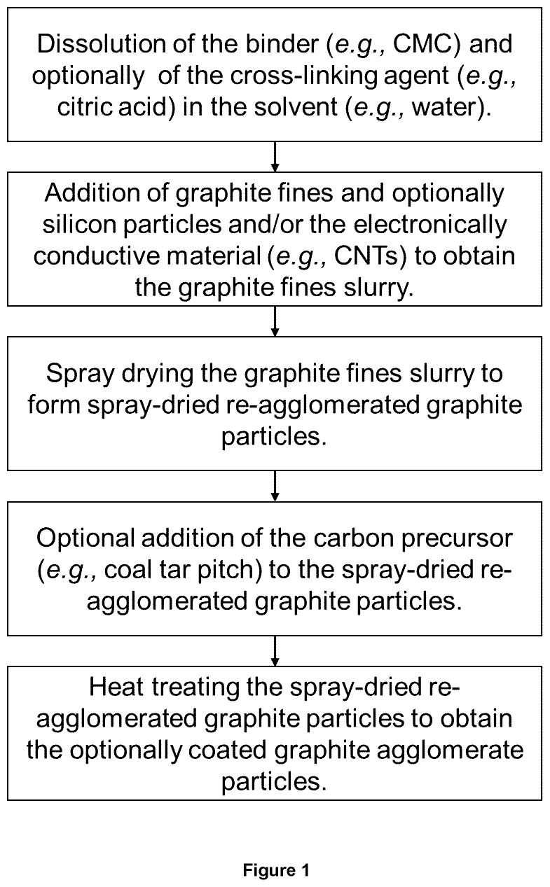

The present technology relates to a method for producing graphite agglomerate particles. For a more detailed understanding of the disclosure, reference is first made to FIG. 1, which provides a flow diagram of a method in accordance with a possible embodiment.

The method for producing the graphite agglomerate particles comprises the steps of:
(i) providing a graphite fines slurry comprising a plurality of graphite fines, a solvent, and a binder;
(ii) spray drying the graphite fines slurry to form spray-dried re-agglomerated graphite particles; and
(iii) heat treating the spray-dried re-agglomerated graphite particles to obtain the graphite agglomerate particles.

Those skilled in the art will appreciate that the method as defined herein can be used to produce graphite agglomerate particles, graphene agglomerate particles, or agglomerate particles comprising both graphite and graphene. In other words, the method and various variations thereon presented throughout the present disclosure may be adapted to completely or partially replace graphite fines with graphene fines. Those skilled in the art will readily understand that the slurry can comprise graphite fines, graphene fines, or both graphite and graphene fines. The graphite fines slurry can be replaced with a graphene fines slurry. It is to be understood that the method for producing the graphene agglomerate particles comprises the steps of:
(i) providing a graphene fines slurry comprising a plurality of graphene fines, a solvent, and a binder;
(ii) spray drying the graphene fines slurry to form spray-dried re-agglomerated graphene particles; and
(iii) heat treating the spray-dried re-agglomerated graphene particles to obtain the graphene agglomerate particles.

For the sake of simplicity and clarity, whenever the present description refers to graphite, it is to be understood that graphene is also contemplated.

In some embodiments, the method as defined herein allows for the revalorization and recycling of graphite fines. For example, graphite fines obtained as a by-product of other processes such as spheroidization.

The graphite fines slurry comprises graphite fines, a solvent, a binder, and optionally at least one cross-linking agent and/or at least one additional component. The graphite fines and, if present, the additional component can be homogeneously dispersed in a solution comprising the solvent, the binder, and optionally the cross-linking agent.

In some embodiments, the binder can be carboxymethyl cellulose (CMC). The graphite fines and, if present, the additional component can be homogeneously dispersed in a solution comprising the solvent, CMC, and a cross-linking agent (e.g., citric acid). For example, the presence of a cross-linking agent can promote the formation of intermolecular rather than intramolecular cross-links, and thereby improve the mechanical properties of the graphite agglomerate particles. Without wishing to be bound by theory, this can be attributed to the electrostatic repulsion between charged macromolecules due to which, few hydroxyl groups remain available for reaction at C6, the most reactive position. In the presence of a cross-linking agent, a cyclic anhydride intermediate can be formed at sufficiently high temperatures, which can esterify the hydroxyl groups present on the adjacent polymer chains, resulting in the formation of cross-links. It is to be understood that the agglomeration process can begin when the slurry comprising the graphite fines, the binder, and the cross-linking agent is fed into the spray dryer.

Spray-drying processes commonly involve three stages, namely (i) atomization, (ii) droplet-to-particle conversion (or particle formation), and (iii) particle collection. In the atomization stage, a spray nozzle (or atomizer) is used to convert the feed solution (i.e., the graphite fines slurry) into substantially fine droplets via atomization. Those skilled in the art will appreciate that the atomization of the feed solution into atomized droplets may allow for a substantial increase of the surface area of the liquid, thereby optimizing the heat and mass transfers between the heated drying gas and the liquid particles in the subsequent phase. In the droplet-to-particle conversion stage, the atomized droplets are exposed to a heated drying medium (e.g., a heated drying gas such as heated air) in a drying chamber to substantially evaporate the solvent. Those skilled in the art will appreciate that the temperature of the drying medium and the residence time of the atomized droplets inside the drying chamber can be optimized to sufficiently evaporate the solvent while substantially or completely avoiding thermal degradation of the particles. Without wishing to be bound by theory, upon contact with the heated drying medium, the temperature of the droplet increases from an initial temperature to an equilibrium evaporation temperature. The drying process can occur at a constant evaporation rate. During the drying process, the droplet surface can remain sufficiently cool and saturated with moisture, thereby keeping its temperature substantially constant at the wet-bulb temperature. Solvent evaporation occurs at a substantially constant rate until a critical value of the droplet moisture content is reached, and a thin shell is formed at the surface of the droplet, thereby slowing down the evaporation process. In the particle collection stage, the newly formed spray-dried re-agglomerated graphite particles are then separated from the drying medium and collected.

In some embodiments, the heat treatment can be performed a temperature and for a period of time sufficient to cure or cross-link, and subsequently carbonize the binder.

### (i) Providing the Graphite Fines Slurry

As previously mentioned, the graphite fines slurry comprises graphite fines, a solvent, a binder, and optionally at least one cross-linking agent and/or additional component.

The method is not limited by any particular graphite fines. The graphite fines can be any conventional graphite fines known in the art. In some embodiments, the graphite fines can be a by-product obtained by a conventional spheroidization process. In some embodiments, the graphite fines have substantially small particle size (e.g., <10 μm).

As previously mentioned, the graphite fines slurry comprises a binder and optionally a cross-linking agent. The binder can bind the graphite fines during the spray drying step, while the cross-linking agent can improve the mechanical strength of the resulting spray-dried re-agglomerated graphite particles and/or graphite agglomerate particles via cross-linking.

Any known compatible binder is contemplated. In some embodiments, the binder is a polymer binder, for example, a polar polymer binder. Non-limiting examples of polymer binders include CMC, polyvinyl alcohol (PVA), polyacrylic acid (PAA), polyethylene glycol (PEG), polyvinylpyrrolidone (PVP), biodegradable polymers, including but not limited to polysaccharides (e.g., cellulose, chitin, starch, glycogen, and pectin), polycaprolactone (PCL), polylactic acid (PLA), polyhydroxy butyrate (PHB), and a combination of at least two thereof. In some other embodiments, the binder is a non-polymeric binder. Non-limiting examples of non-polymeric binders include glycerin, pentaerythritol, a monosaccharide, a disaccharide (e.g., sucrose), other similar compounds, and a combination of at least two thereof. In some embodiments of interest, the binder is CMC.

Any known compatible cross-linking agent is contemplated. For example, the cross-linking agent can be an organic cross-linking agent or an inorganic cross-linking agent. In some embodiments of interest, the cross-linking agent is an organic cross-linking agent. Non-limiting examples of organic cross-linking agents include citric acid, formic acid, acetic acid, oxalic acid, and a combination of at least two thereof. Non-limiting examples of inorganic cross-linking agents include, divalent metal ions such as Cu²⁺, Zn²⁺, Mg²⁺, Ca²⁺, and a combination of at least two thereof. In some embodiments of interest, the cross-linking agent is citric acid.

Any known compatible solvent is contemplated. For example, the solvent can be any compatible solvent conventionally used in spray drying. For example, the solvent can be an aqueous solvent. Non-limiting examples of solvents include water, methanol, acetone, ethanol, dichloromethane, tetrahydrofuran, ethyl acetate, chloroform, glycerin, dimethylformamide, dimethyl sulfoxide, and a miscible combination of at least two thereof. In some embodiments of interest, the solvent is water.

The mass ratio of graphite fines to binder can be optimized to obtain agglomerated graphite particles having desired properties (e.g., size). Those skilled in the art will appreciate that decreasing the mass ratio of graphite fines to binder in the graphite fines slurry can increase the granule size of the resulting spray-dried re-agglomerated graphite particles and/or graphite agglomerate particles. If the mass ratio of graphite fines to binder is below a certain threshold, binder solubility may become an issue, while if the mass ratio of graphite fines to binder is above a certain threshold, there may not be enough binder, meaning that agglomeration of the graphite particles may not occur or may not sufficiently occur. In some embodiments, the mass ratio of graphite fines to binder in the graphite fines slurry is between about 4:1 and about 20:1, upper and lower limits included. In some embodiments, the mass ratio of graphite fines to binder in the graphite fines slurry is at least about 4:1, or at least about 5:1, or at least about 6:1, or at least about 7:1. In some embodiments, the mass ratio of graphite fines to binder in the graphite fines slurry is at most about 20:1, or at most about 15:1, or at most about 10:1, or at most about 8:1. In some embodiments of interest, the mass ratio of graphite fines to binder in the graphite fines slurry is about 6:1.

The content of graphite fines in the graphite fines slurry can play a role in the granule size of the resulting spray-dried re-agglomerated graphite particles and/or graphite agglomerate particles, as the D₅₀ of the resulting spray-dried re-agglomerated graphite particles and/or graphite agglomerate particles generally increases with the amount of graphite fines. In some embodiments, the weight concentration (wt/wt % or w/w %) of graphite fines in the graphite fines slurry is between about 14 wt. % and about 35 wt. %, upper and lower limits included. In some embodiments, the graphite fines slurry comprises at least about 14 wt. %, or at least about 18 wt. %, or at least about 21 wt. %, or at least about 24 wt. % of graphite fines. In some embodiments, the graphite fines slurry comprises at most about 35 wt. %, or at most about 33 wt. %, or at most about 30 wt. %, or at most about 28 wt. % of graphite fines. In some embodiments of interest, the graphite fines slurry comprises about 24 wt. % of graphite fines.

The mass ratio of graphite fines to binder may affect the amount of graphite fines or binder that can be the slurry. For example, if the graphite fines content is high and the mass ratio of graphite fines to binder is low, then the quantity of binder may be too high to sufficiently dissolve in the solvent. On the other hand, a lower graphite fines content (e.g., 18 wt. %) may allow for lower mass ratios of graphite fines to binder (e.g., 4:1) without substantially having binder dissolution issues. In light of the above, in some embodiments of interest, a graphite fines content of about 14 wt. % may be combined with a mass ratio of graphite fines to binder that is lower than about 10:1, while a graphite fines content of about 35 wt. % may be combined with a mass ratio of graphite fines to binder that is higher than about 8:1. Therefore, while the graphite fines slurry may comprise 14 wt. % of graphite fines or a mass ratio of graphite fines to binder of 20:1, the former is preferably combined with a lower mass ratio of graphite fines to binder (e.g., s 10:1), while the latter is preferably combine with a higher graphite fines content (e.g., 21 wt. %). In some embodiments of interest, the graphite fines slurry can comprise a binder content of about 1.4 wt. %, a graphite fines content of about 14 wt. %, and a mass ratio of graphite fines to binder of about 10:1.

The graphite fines can be purified graphite fines or unpurified graphite fines. In some embodiments of interest, the graphite fines are purified graphite fines and the method may further comprise a step of purifying the graphite fines. The purification step may be performed by any known compatible purification methods.

In some embodiments, the purity of the graphite fines is between about 99.70% and about 99.99%, upper and lower limits included. In some embodiments, the purity of the graphite fines is at least about 99.70%, or at least about 99.8%, or at least about 99.9%, or at least about 99.95%. In some embodiments, the purity of the graphite fines is at most about 99.99%, or at most about 99.95%. In some embodiments of interest, the purity of the graphite fines is about 99.95%, which is a purity level commonly accepted for battery applications.

The D₅₀ of the graphite fines can play a role in the granule size of the resulting spray-dried re-agglomerated graphite particles and/or graphite agglomerate particles. Those skilled in the art will appreciate that the D₅₀ of the spray-dried re-agglomerated graphite particles and/or graphite agglomerate particles can increase with the D₅₀ of the graphite fines because the D₅₀ of the spray-dried re-agglomerated graphite particles and/or graphite agglomerate particles cannot be lower than the D₅₀ of the graphite fines that comprise in the spray-dried re-agglomerated graphite particles and/or graphite agglomerate particles. In some embodiments, the D₅₀ of the graphite fines is between about 3 μm and about 10 μm, upper and lower limits included. In some embodiments, the D₅₀ of the graphite fines is at least about 3 μm, or at least about 4 μm, or at least about 5 μm, or at least about 6 μm. In some embodiments, the D₅₀ of the graphite fines is at most about 10 μm, or at most about 9 μm, or at most about 8 μm, or at most about 7 μm. In some embodiments of interest, the D₅₀ of the graphite fines is about 7 μm.

The D₅₀ of the resulting graphite agglomerate particles may be optimized based on the intended use of the graphite agglomerate particles. In some embodiments, the graphite agglomerate particles are used in small-scale batteries and the D₅₀ of the graphite agglomerate particles can be between about 18 μm and about 21 μm, upper and lower limits included. In some other embodiments, the graphite agglomerate particles are used in large-scale batteries (such as batteries for use in electric vehicles) and the D₅₀ of the graphite agglomerate particles can be between about 20 μm and about 24 μm, upper and lower limits included. In some other embodiments, the graphite agglomerate particles are used in mid-scale batteries (such as batteries for use in hybrid electric vehicles) and the D₅₀ of the graphite agglomerate particles can be between about 13 μm and about 17 μm, upper and lower limits included.

The D50 of the resulting spray-dried re-agglomerated graphite particles and/or graphite agglomerate particles can increase with the amount of binder in the graphite fines slurry. This can be attributed to the resulting in the viscosity of the graphite fines slurry, which can reduce the atomization energy available to create the droplets. It is to be understood that an amount of binder sufficient to bind the graphite fines, while the upper limit of binder present in the graphite fines slurry can be limited by the solubility of the binder in the solvent. In some embodiments, the graphite fines slurry comprises between about 0.7 wt. % and about 6.0 wt. %, upper and lower limits included, of the binder. In some embodiments, the graphite fines slurry comprises at least about 0.7 wt. %, or at least about 1.4 wt. %, or at least about 2.5 wt. %, or at least about 3.0 wt. % of the binder. In some embodiments, the graphite fines slurry comprises at most about 6.0 wt. %, or at most about 5.0 wt. %, or at most about 4.5 wt. %, or at most about 4.0 w/w % of the binder. In some embodiments of interest, the graphite fines slurry comprises about 4.0 wt. % of the binder.

The D₅₀ of the resulting spray-dried re-agglomerated graphite particles and/or graphite agglomerate particles can increase with the amount of cross-linking agent if present in the graphite fines slurry, likely because it can promote a higher degree of polymerization. In some embodiments, the graphite fines slurry comprises between about 0.5 wt. % and about 4.0 wt. %, upper and lower limits included, of the cross-linking agent. In some embodiments, the graphite fines slurry comprises at least about 0.5 wt. %, or at least about 1.0 wt. %, or at least about 1.5 wt. %, or at least about 2.0 wt. % of the cross-linking agent. In some embodiments, the graphite fines slurry comprises at most about 4 wt. %, or at most about 3.5 wt. %, or at most about 3.0 wt. %, or at most about 2.5 wt. % of the cross-linking agent. In some embodiments, the graphite fines slurry comprises about 3.0 wt. % of the cross-linking agent.

The D₅₀ of the resulting spray-dried re-agglomerated graphite particles and/or graphite agglomerate particles can decrease with the amount of solvent in the graphite fines slurry, likely because it can dilute the graphite fines content in the graphite fines slurry, and therefore it can decrease the amount of graphite fines available for agglomeration. In some embodiments, the graphite fines slurry comprises between about 58 wt. % and about 83 wt. %, upper and lower limits included, of the solvent. In some embodiments, the graphite fines slurry comprises at least about 53 wt. %, or at least about 58 wt. %, or at least about 62 wt. %, or at least about 66 wt. % of the solvent. In some embodiments, the graphite fines slurry comprises at most about 83 wt. %, or at most about 80 wt. %, or at most about 72 wt. %, or at most about 69 wt. % of the solvent. In some embodiments, the graphite fines slurry comprises about 69 wt. % of the solvent.

Those skilled in the art will appreciate that the optimal amount of solvent in the graphite fines slurry may depend on different parameters. For example, a low amount of solvent of about 53 wt. % may work when the graphite fines content is about 35 wt. % and the mass ratio of graphite fines to binder is about 4:1. However, in such an example, the resulting binder content would be 8.7 wt. %, which, if CMC is the binder, can be impossible to dissolve in only about 53 wt. % of the solvent (assuming the solvent is water). Conversely, a combination of about 35 wt. % graphite fines content with a mass ratio of graphite fines to binder of about 8:1 can be possible with a solvent content of 58 wt. % (if the binder is CMC and the solvent is water).

In some embodiments of interest, the graphite fines slurry comprises about 24 wt. % of graphite fines, about 4.0 wt. % of the binder, about 3.0 wt. % of the cross-linking agent, and about 69 wt. % of the solvent.

In some embodiments, providing a graphite fines slurry comprises preparing the graphite fines slurry. In some embodiments of interest, the graphite fines slurry is prepared by combining the graphite fines, the binder, the solvent, optionally the cross-linking agent, and optionally the additional component, and then mixing the components together. The mixing step may be performed by any known compatible mixing methods, for example, the mixing step may be performed using a mixer. In some embodiments of interest, the mixing step may be performed using a resonant acoustic mixer. For example, the mixing step may be performed at an acceleration and for a period of time sufficient to substantially homogeneously disperse the graphite fines. For instance, the mixing step may be performed using a resonant acoustic mixer at an acceleration of about 50 G for about 30 minutes.

In some embodiments, the graphite fines slurry may further comprise silicon particles. In such embodiments, the spray-dried re-agglomerated graphite particles resulting from the spray drying step and the graphite agglomerate particles resulting from the heat treatment step can also comprise said silicon particles.

The D₅₀ of the silicon particles in the graphite slurry can be between about 50 nm and about 5 μm, upper and lower limits included. In some embodiments, the content of silicon particles in the graphite fines slurry can be between about 0.0014 wt. % and about 17.5 wt. %, upper and lower limits included. For example, these can correspond to silicon content of about 0.01 wt. % and about 50 wt. % in the resulting agglomerate, when the graphite fines slurry comprises a minimum of about 14 wt. % and a maximum of about 35 wt. % active material (graphite fines/silicon particles), respectively.

In some embodiments, the graphite fines slurry may further comprise graphene particles and/or graphite fines. In such embodiments, the spray-dried re-agglomerated graphite particles resulting from the spray drying step and the agglomerate graphite particles resulting from the heat treatment step comprise both graphite and graphene agglomerate particles.

The D50 of the graphene particles in the slurry can be between about 50 nm and about 20 μm, upper and lower limits included. For example, the D50 of the graphene particles in the slurry can be between about 50 nm and about 18 μm, or between about 50 nm and about 16 μm, or between about 50 nm and about 14 μm, or between about 50 nm and about 12 μm, or between about 50 nm and about 10 μm, or between about 50 nm and about 8 μm, or between about 50 nm and about 6 μm, or between about 50 nm and about 5 μm, upper and lower limits included.

In some embodiments, the graphite fines slurry may further comprise an electronically conductive material. For example, the electronically conductive material can be a carbon source. Non-limiting examples of electronically conductive materials include carbon black (e.g., Ketjen™ carbon and Super P™ carbon), acetylene black (e.g., Shawinigan carbon and Denka™ carbon black), carbon fibers (e.g., vapor grown carbon fibers (VGCFs)), carbon nanofibers, CNTs (e.g., single-walled carbon nanotubes (SWCNTs), multi-walled carbon nanotubes (MWCNTs), and a combination thereof), and a combination of at least two thereof. In some embodiment of interest, the graphite fines slurry further comprises CNTs. In some embodiments, the graphite fines slurry comprises between about 0.1 wt. % and about 3.0 wt. % of CNTs, upper and lower limits included. For example, the graphite fines slurry comprises between about 0.1 wt. % and about 2.8 wt. %, or between about 0.1 wt. % and about 2.6 wt. %, or between about 0.1 wt. % and about 2.4 wt. %, or between about 0.1 wt. % and about 2.2 wt. %, or between about 0.1 wt. % and about 2.0 wt. %, or between about 0.1 wt. % and about 1.8 wt. %, or between about 0.1 wt. % and about 1.6 wt. %, or between about 0.1 wt. % and about 1.4 wt. %, or between about 0.1 wt. % and about 1.2 wt. %, or between about 0.2 wt. % and about 1.0 wt. %, or between about 0.3 wt. % and about 1.0 wt. %, or between about 0.4 wt. % and about 1.0 wt. %, or between about 0.5 wt. % and about 1.0 wt. %, or between about 0.6 wt. % and about 1.0 wt. %, or between about 0.7 wt. % and about 1.0 wt. %, or between about 0.8 wt. % and about 1.0 wt. %, or between about 0.9 wt. % and about 1.0 wt. % of CNTs, upper and lower limits included. In some embodiments of interest, the graphite fines slurry comprises between about 0.8 wt. % and about 1.1 wt. % of CNTs, upper and lower limits included.

In some embodiments of interest, the graphite fines slurry may further comprise both an electronically conductive material and silicon particles. In some preferred embodiments, the graphite fines slurry may further comprise both CNTs and silicon particles.

### (ii) Spray Drying Step

The spray drying step comprises spray drying the graphite fines slurry to obtain spray-dried re-agglomerated graphite particles. Any compatible spray drying system is contemplated.

Those skilled in the art will appreciate that several spray drying parameters can be optimized to obtain spray-dried re-agglomerated graphite particles and subsequent graphite agglomerate particles having desired properties (e.g., particle size, size distribution, and morphology). For example, key process parameters including the feed rate of the graphite fines slurry, the inlet and outlet humidity and temperature, and/or the heated drying medium flow rate can be optimized to obtain spray-dried re-agglomerated graphite particles and subsequent graphite agglomerate particles having desired properties. In some embodiments, these key process parameters can be similar to those used in conventional spray drying processes. Those skilled in the art would readily understand that these key process parameters can be adapted to suit a particular situation (e.g., laboratory scale spray drying processes typically utilizes different process parameters than commercial scale spray drying processes). For sake of clarity, the paragraphs below discussing feed rate, inlet temperature, and heated drying medium flow rate are generally referring to laboratory scale spray drying process parameters. However, those skilled in the art would readily be able to adjust these process parameters to commercial scale spray drying processes.

The D₅₀ of the resulting spray-dried re-agglomerated graphite particles and graphite agglomerate particles can increase with the graphite fines slurry feed rate of the spray drying step (ii). Without wishing to be bound by theory, at constant atomization pressure, there is an increase in the droplet size with increasing graphite fines slurry feed rates, which results in a decrease in outlet temperature, since the nozzle (or atomizer) has to atomize more liquid with the same energy. In some embodiments, the graphite fines slurry feed rate is between about 10 mL·min⁻¹ and about 22 mL·min⁻¹, upper and lower limits included. In some embodiments, the graphite fines slurry feed rate is at least about 10 mL·min⁻¹, or at least about 12 mL·min⁻¹, or at least about 14 mL·min⁻¹, or at least about 16 mL·min⁻¹. In some embodiments, the graphite fines slurry feed rate is at most about 22 mL·min⁻¹, or at most about 21 mL·min⁻¹, or at most about 20 mL·min⁻¹, or at most about 18 mL·min⁻¹. In some embodiments of interest, the graphite fines slurry feed rate is about 20.3 mL·min⁻¹.

The D₅₀ of the resulting spray-dried re-agglomerated graphite particles and graphite agglomerate particles decreases with the inlet temperature of the spray drying step (ii), likely because it increases the dryer evaporative capacity and thermal efficiency, which decreases residual moisture. In some embodiments, the inlet temperature is between about 190° C. and about 220° C., upper and lower limits included. In some embodiments, the inlet temperature is at least about 190° C., or at least about 200° C. In some embodiments, the inlet temperature is at most about 220° C., or at most about 210° C. In some embodiments of interest, the inlet temperature is about 210° C.

In some embodiments, the heated drying medium flow rate is between about 2.0 m³·min⁻¹ and about 2.5 m³·min⁻¹, upper and lower limits included.

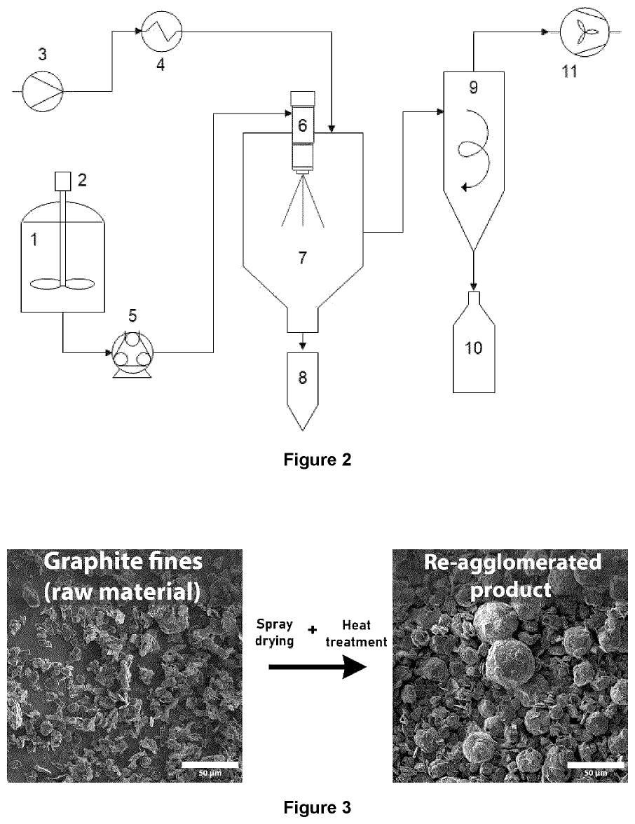

Reference is now made to FIG. 2, which provides a schematic representation of a spray dryer system (and process) for the agglomeration of graphite fines in accordance with a possible embodiment. In some embodiments, the graphite fines, the binder (e.g., CMC), optionally the cross-linking agent (e.g., citric acid), optionally at least one additional component (e.g., graphene particles, graphene fines, silicon particles, an electronically conductive material (e.g., CNTs), and a combination of at least two thereof), and the solvent (e.g., water) can be mixed in a feed tank (1) using a mixer (e.g., a resonant acoustic mixer) (2). The resulting mixture can then be fed to an atomizer nozzle (6) via a pump (e.g., a peristaltic pump) (5). The atomizer can then disperse the liquid stream into a controlled drop size spray which can then be rapidly dried in a drying chamber (7) with a heated drying medium (e.g., heated air) provided by a pump (3) and a drying medium heater (e.g., an air heater) (4). Fine, dry particles can then fall into a dust collector (8), while bigger particles (spray-dried re-agglomerated graphite particles) pass to a separator (e.g., a cyclone separator) (9) driven by the drying medium flow, where they can be collected in a product collection vessel (10), for example, using centrifugal force. The heated medium can then be extracted via an extraction fan (11).

(iii) Heat Treatment Step

The next step (iii) is to subject the spray-dried re-agglomerated graphite particles to heat treatment to obtain graphite agglomerate particles. Any compatible heat treatment method is contemplated. By heat treating the spray-dried re-agglomerated graphite particles, at least a portion of volatile materials are removed therefrom.

Optionally, the spray-dried re-agglomerated graphite particles obtained from spray drying the graphite fines slurry can be mixed with a carbon precursor prior to heat treatment to produce carbon-coated graphite agglomerate particles. Carbon coating may be performed or omitted depending on the desired final product. For example, when the user wishes to obtain uncoated graphite agglomerate particles, then the carbon coating would be omitted entirely. Conversely, when the user wishes to obtain carbon-coated graphite agglomerate particles, then the heat treatment may be performed with the use of the carbon precursor. Properties of each of these final products (as well as properties of electrodes made therefrom), including how properties of said final products vary with parameters presented herein, are described in more detail throughout the specification.

Any compatible carbon precursor is contemplated. For example, the carbon precursor can be any carbon precursor conventionally used to coat particles with a carbon material via heat treatment. Non-limiting examples of carbon precursors include petroleum pitch, coal tar pitch, biomass pitch, a combination of at least two thereof, and any similar compatible material. In some embodiments of interest, the carbon precursor is coal tar pitch. When pitch is used, for example coal tar pitch, the resulting graphite agglomerate particles will be pitch-coated graphite agglomerate particles.

The carbon material may form a homogeneous coating layer on the surface of the graphite agglomerate particles. For example, the carbon material may form a substantially uniform coating layer on the surface of the graphite agglomerate particles. Alternatively, the carbon material may form a coating layer on at least a portion of the surface of the graphite agglomerate particles. For instance, the carbon material may be heterogeneously dispersed on the surface of the graphite agglomerate particles.

The graphite agglomerate particles will be about the same size as the spray-dried re-agglomerated graphite particles that are heat treated. However, it is to be understood that coating the graphite agglomerate particles with carbon material will naturally result in graphite agglomerate particles having a slightly increased diameter compared to the corresponding spray-dried re-agglomerated graphite particles, due to the presence of the coating layer.

In some embodiments, the heat treatment is performed at a temperature and for a period of time sufficient to decompose the binder and, if present, the cross-linking agent. Those skilled in the art will appreciate that the heat treatment conditions (e.g., temperature, duration, heating rate, ramp-up time, etc.) can be optimized to decompose the binder and, if present, the cross-linking agent substantially or completely. It is to be understood that the heat treatment conditions can be optimized based on the sample size and/or the nature binder and, if present, the nature of the cross-linking agent. In some embodiments, substantial or complete decomposition of the binder can be achieved at a temperature of about 1100° C. In some embodiments, the heat treatment step (iii) is performed by heating the spray-dried re-agglomerated graphite particles at a temperature between about 550° C. and about 1300° C., upper and lower limits included. In some embodiments, the spray-dried re-agglomerated graphite particles are heated to a temperature of at least about 550° C., or at least about 600° C., or at least about 700° C., or at least about 750° C. In some embodiments, the spray-dried re-agglomerated graphite particles are heated to a temperature of at most about 1300° C., or at most about 1100° C., or at most about 1000° C., or at most about 900° C. In some embodiments of interest, the spray-dried re-agglomerated graphite particles are heated to a temperature of about 1000° C.

Any compatible heat treatment method is contemplated. For example, the heat treatment step (iii) can be performed using conventional heat treatment methods for natural graphite. In some embodiments, the heat treatment step (iii) is performed in a laboratory furnace (e.g., tube furnace) or an industrial furnace. For example, the heat treatment step (iii) can be performed under an inert atmosphere, for example, the heat treatment step (iii) can be performed under an inert gas flow, such as an argon (Ar) or nitrogen (N₂) flow. In some embodiments, the heat treatment profile comprises ramp heating from room temperature to about 400° C. (2.00° C./min ramp), isothermal heating at about 400° C. for about 2 hours, a second ramp heating from about 400° C. to about 900° C. (2.00° C./min ramp), followed by isothermal heating at about 900° C. for about 2 hours. In some embodiments, the sample comprises CMC as the binder and citric acid a cross-linking agent and the CMC/CA mass loss due to carbonization during heat treatment step (iii) is about 80%, which can account for about 18% of the total heat-treated mass.

When carbon-coated graphite agglomerate particles are desired, any compatible coating method is contemplated. For example, any conventional technique used to coat graphite particles with a carbon material via heat treatment can be used. For instance, the spray-dried re-agglomerated graphite particles and the carbon precursor can be mixed using a wet or dry mixing method. In some embodiments, the spray-dried re-agglomerated graphite particles obtained in step (ii) are mixed with petroleum pitch (ZL 250M) (e.g., 9:1 mass ratio) using a resonant acoustic mixer (e.g., at an acceleration of about 50 G for about 15 minutes), followed by a heat treatment for the thermal decomposition of the petroleum pitch. In some embodiments, the heat treatment profile comprises a single temperature ramp from room temperature to about 1000° C. (2.00° C./min ramp) followed isothermal heating at about 1000° C. for about 30 minutes. The thermal decomposition can be performed under inert gas flow, such as an argon (Ar) or nitrogen (N₂) flow.

In some embodiments, the carbon precursor is added to the spray-dried re-agglomerated graphite particles in a sufficient amount to cover the entire surface of the spray-dried re-agglomerated graphite particles. In some embodiments, the carbon precursor is mixed with the spray-dried re-agglomerated graphite particles such that the carbon precursor represents between about 5 wt. % and about 30 wt. %, upper and lower limits included, of the mixture comprising the spray-dried re-agglomerated graphite particles and the carbon precursor. In some embodiments, the amount of carbon precursor in the mixture comprising the spray-dried re-agglomerated graphite particles and carbon precursor is at least about 5 wt. %, or at least about 10 wt. %, or at least about 15 wt. %. In some embodiments, the amount of carbon precursor in the mixture comprising the spray-dried re-agglomerated graphite particles and carbon precursor is at most about 30 wt. %, or at most about 25 wt. %, or at most about 20 wt. %. In some embodiments of interest, the amount of carbon precursor in the mixture comprising the spray-dried re-agglomerated graphite particles and carbon precursor is about 10 wt. %.

In some embodiments, binder carbonization and carbon coating can be performed via a single heat treatment step process (referred as 1-step HT hereinafter). In some embodiments, the CMC/citric acid/carbon precursor mass loss due to decomposition during the 1-step HT can be about 69%, which can account for about 21% of the total heat-treated mass. In some alternative embodiments, binder carbonization and carbon coating can be performed via a two-step process, wherein the spray-dried re-agglomerated graphite particles are first heat treated to form graphite agglomerate particles, and then said graphite agglomerate particles are mixed with the carbon precursor. After, a second heat treatment step for carbon coating is performed (referred as 2-step HT hereinafter). In some embodiments, the carbon precursor (e.g., pitch) mass loss due to carbonization via the 2-step HT can be about 47% (i.e., about 4.7% of total heat-treated mass).

Those skilled in the art will appreciate that the parameters (or process conditions) used in the heat treatment step (iii) may impact the properties of the resulting graphite agglomerate particles. For example, in some embodiments, the graphite agglomerate particles can comprise nano-grains having a diameter of from about 20 nm to about 200 nm, upper and lower limits included. The nano-grains can be disposed on the surface of the graphite agglomerate particles. The presence of these nano-grains can likely be attributed to the carbonization of the binder (e.g., CMC) and, if present, the cross-linking agent (e.g., citric acid) which may lead to the formation of nano- and micro-sized grains and spheres. On the other hand, in some embodiments, the carbon-coated graphite agglomerate particles obtained through 1-step HT may exhibit a smoother surface with respect to its non-coated counterpart, while following the overall shape of the graphite agglomerate particles. In some embodiments, the presence of nano-grains might be substantially diminished by the carbon coating. However, in some embodiments, the nano-grains may still be present on the surface of carbon-coated graphite agglomerate particles obtained through 2-step HT.

It is worth mentioning that carbon coating (both 1-step HT and 2-step HT) may decrease the surface area of the graphite agglomerate particles due to the coverage of pores (e.g., <10 nm), which can be a desired effect of the surface modification by carbon coating.

In some embodiments of interest, the heat treatment is performed in the presence of the carbon precursor (e.g., coal pitch tar), preferably using 1-step HT.

For sake of clarity, the expression “spray-dried re-agglomerated graphite particles” refers to the product obtained from the spray drying step (ii), while the expression “graphite agglomerate particles” refers to the product obtained through the heat treatment step (iii) as defined herein. As mentioned, the properties of said graphite agglomerate particles (carbon-coated vs uncoated, etc.) will depend on whether the carbon-coating is performed or not, and the parameters (or process conditions) of the heat treatment (e.g., 1-step HT or 2-step HT).

The skilled person would understand that while the method presented herein comprises a heat treatment step, said step may be performed non-continuously from the other steps (i.e., in a separate location or by a different entity). Accordingly, in certain embodiments, the method steps (i) and (ii) can be performed by a first entity, the product thereof (i.e., the spray-dried re-agglomerated graphite particles) can thereafter be sold or transferred to another entity before step (iii) is performed (e.g., at a different location).

As mentioned, FIG. 1 illustrates an embodiment of the method as defined herein. In the embodiment shown in FIG. 1, the binder (e.g., CMC), and the optional a cross-linking agent (e.g., citric acid) are dissolved in the solvent (e.g., water), followed by the addition of graphite fines (raw material). The graphite fines slurry thus obtained is then subjected to spray drying, which produces substantially spherical spray-dried re-agglomerated graphite particles which can have a median particle size of about 17 μm. As illustrated in FIG. 1, the next step of the method can comprise mixing the spray-dried re-agglomerated graphite particles with the carbon precursor (e.g., coal tar pitch) in a mass ratio of 9:1 and subjecting the mixture to heat treatment at temperature of about 1000° C. under an inert atmosphere for simultaneous binder carbonization and particle coating with carbon. For example, coating the particles with carbon can substantially reduce the surface reactivity of the graphite agglomerate particles with the electrolyte of an electrochemical cell, which can improve its electrochemical performances. As these two processes (binder carbonization and particle coating with carbon) can be achieved in a single heat treatment step, the efficiency of the overall method can be increased.

In some embodiments, the spray-dried re-agglomerated graphite particles are further subjected to a high temperature heat treatment performed at a temperature between about 2000° C. and about 3000° C., upper and lower limits included. This can be done, for example, to transform an amorphous carbon coating and/or the binder into a more graphitized material.

The graphite agglomerate particles obtained by the method presented herein are described in more detail in the subsequent section. FIG. 3 shows SEM images of the graphite fines (raw material) and the graphite agglomerate particles obtained by an embodiment of the method disclosed herein.

### Graphite Agglomerate Particles

The present technology also relates to graphite agglomerate particles comprising agglomerated graphite fines. For example, the graphite agglomerate particles can be produced using the method as defined herein.

In some embodiments of interest, the graphite agglomerate particles are spherical-shaped particles or near-spherical-shaped particles (meaning they have a quasi-spherical morphology).

As mentioned previously, the D₅₀ of the graphite agglomerate particles may differ depending on the intended use of the graphite agglomerate particles. For example, for small-scale batteries, the preferred D₅₀ is between about 18 μm and about 21 μm, upper and lower limits included. For large-scale batteries (such as batteries for use in electric vehicles), the preferred D₅₀ is between about 20 μm and about 24 μm, upper and lower limits included. For mid-scale batteries (such as batteries for use in hybrid electric vehicles), the preferred D₅₀ is between about 13 μm and about 17 μm, upper and lower limits included.

In some embodiments, the graphite agglomerate particles comprise graphite with Bernal (2H) phase, rhombohedral (3R) phase, or both 2H and 3R phases, and may retain the crystalline structure of the graphite fines raw material. In some embodiments of interest, the graphite agglomerate particles comprise graphite with both 2H and 3R phases. Accordingly, in some embodiments, the method described herein does not substantially change the crystalline structure of the graphite fines used to produce the graphite agglomerate particles.

In some embodiments, the graphite agglomerate particles may be carbon-coated graphite agglomerate particles. For example, the graphite agglomerate particles may be pitch-coated graphite agglomerate particles.

As previously mentioned, in some embodiments, the graphite agglomerate particles are optionally subjected to a further high-temperature heat treatment performed at a temperature between about 2000° C. and about 3000° C., upper and lower limits included. Those skilled in the art will appreciate that when using such high temperatures, the crystalline structure of the graphite may be slightly more modified compared to embodiments of the method exempt of said additional high-temperature heat treatment step (i.e., embodiments of the method using lower temperatures).

In some embodiments, the graphite agglomerate particles can further comprise silicon particles. In some embodiments, the silicon content in the graphite agglomerate particles is greater than 0 wt. %. In some embodiments, the silicon content in the graphite agglomerate particles is at least about 3 wt. %. In some embodiments, the silicon content in the graphite agglomerate particles is at most about 50 wt. %, or at most about 33 wt. %.

In some other embodiments, the teachings presented herein in relation to the graphite agglomerate particles can be modified by substituting at least a part of the graphite fines with silicon particles. As such, the teachings presented herein may be applied to with a silicon content of at least about 35 wt. %, or at least about 95 wt. %, or as high as 100 wt. %.

In some embodiments, the graphite agglomerate particles can further comprise an electronically conductive material (such as an electronically conductive material as previously defined). In some embodiment of interest, the graphite agglomerate particles further comprise CNTs.

In some embodiments of interest, the graphite agglomerate particles can further comprise both an electronically conductive material and silicon particles. In some preferred embodiments, the graphite agglomerate particles may further comprise both CNTs and silicon particles.

### Applications of the Graphite Agglomerate Particles

The present technology also relates to the use of the graphite agglomerate particles as defined herein (e.g., produced by the method as defined herein) in electrode materials, electrodes, electrochemical cells, and batteries.

An electrode material comprising the graphite agglomerate particles (carbon-coated or not) as defined herein. In some embodiments, the electrode material comprises the graphite agglomerate particles as defined herein and at least one additional component. In some other embodiments, the electrode material is made of the graphite agglomerate particles as defined herein. In some embodiments of interest, the graphite agglomerate particles as defined herein is present in the electrode material at weight concentration (wt/wt %) in the range of from about 70 wt. % to about 100 wt. %, upper and lower limits included.

In some embodiments, the electrode material as defined herein can further comprise an electronically conductive material. Non-limiting examples of electronically conductive materials include a carbon source such as carbon black (e.g., Ketjen™ carbon and Super P™ carbon), acetylene black (e.g., Shawinigan carbon and Denka™ carbon black), graphite, graphene (e.g., graphene nanoplatelets), carbon fibers (e.g., VGCFs), carbon nanofibers, CNTs (e.g., SWCNTs, MWCNTs, and a combination thereof), and a combination of at least two thereof. In some embodiments of interest, the electronically conductive material comprises carbon black, CNTs, or a combination thereof. In some embodiments of interest, the electronically conductive material is present in the electrode material at weight concentration (wt/wt %) in the range of from about 0.05 wt. % to about 10 wt. %, upper and lower limits included.

In some embodiments, the electrode material as defined herein can further comprise at least one additive. The additive can be selected from inorganic ionic conductive materials, inorganic materials, glasses, glass-ceramics, ceramics, including nano-ceramics (e.g., Al₂O₃, TiO₂, SiO₂, and other similar compounds), salts (e.g., lithium salts), and a combination of at least two thereof. In some embodiments of interest, the additive can be a hard carbon.

In some embodiments, the electrode material as defined herein can further comprise a binder. The binder can be selected for its compatibility with the various elements of an electrochemical cell. Any known compatible binder is contemplated. For example, the binder may be selected from a polymer binder of the polyether, polycarbonate or polyester type, a fluorinated polymer, and a water-soluble binder. In some embodiments, the binder is a fluorinated polymer such as polyvinylidene fluoride (PVDF) or polytetrafluoroethylene (PTFE). In some other embodiments, the binder is a water-soluble binder such as styrene-butadiene rubber (SBR), acrylonitrile-butadiene rubber (NBR), hydrogenated NBR (HNBR), epichlorohydrin rubber (CHR), or acrylate rubber (ACM), and optionally comprising a thickening agent such as CMC, or a polymer such as poly(acrylic acid) (PAA), poly(methyl methacrylate) (PMMA), or a combination of at least two thereof. In some other embodiments, the binder is a polymer binder of the polyether type. For example, the polymer binder of the polyether type is linear, branched and/or cross-linked and is based on poly(ethylene oxide) (PEO), poly(propylene oxide) (PPO), or a combination thereof (such as an EO/PO copolymer), and optionally comprises cross-linkable units. In some embodiments of interest, the binder comprises CMC and SBR (e.g., at a mass ratio of about 30:70) as a binder. In some embodiments of interest, the binder is present in the electrode material at weight concentration (wt/wt %) in the range of from about 1 wt. % to about 20 wt. %, upper and lower limits included.

In some embodiments of interest, the electrode material is an anode material.

An electrode comprising the electrode material as defined herein applied on a current collector (e.g., an aluminum or a copper foil) is also contemplated. Alternatively, the electrode may be a self-supported electrode. In some embodiments of interest, the electrode as defined herein is an anode. For example, the electrode material as defined herein can act as the active material when the electrode is used in an electrochemical cell or a battery.

The electrode can be calendered or not. In some embodiments of interest, the electrode is calendered.

In some embodiments, the electrodes prepared using the graphite agglomerate particles as defined herein (e.g., produced by the method as defined herein) exhibit electrochemical properties that are comparable to those obtained using conventional electrodes prepared using conventional graphite, such that electrodes prepared using the graphite agglomerate particles as defined herein (e.g., produced by the method as defined herein) can be used in any compatible electrochemical cell or battery such as a conventional LIB.

In some embodiments, the electrodes prepared using the graphite agglomerate particles as defined herein (e.g., produced by the method as defined herein) can comprise a first discharge/charge capacity of 418±13/351±9 mAh·g⁻¹, 410±4/351±6 mAh·g⁻¹, or 415±4/350±2 mAh·g⁻¹, which translates into an initial Coulombic efficiency of 84%, 86%, or 84% for graphite agglomerate particles, pitch-coated graphite agglomerate particles (1-step HT), and pitch-coated graphite agglomerate particles (2-step HT), respectively.

In some embodiments, the electrodes are obtained using carbon-coated graphite agglomerate particles as defined herein (preferably obtained using 1-step HT as defined previously). Those skilled in the art will appreciate that the carbon coating can act as a protective layer to restrain the volume expansion of graphite during cycling (e.g., during lithium intercalation) and/or to stabilize the SEI layer.

In some embodiments, when compared to conventional graphite electrodes such as electrodes comprising PGPT102 commercial graphite, the cathodic peaks on electrodes obtained using the carbon-coated graphite agglomerate particles as defined herein may be observed at more positive potentials, while anodic peaks may appear at slightly lower positive potentials, which could indicate better electronic conductivity of these electrodes. In addition, electrodes obtained using the uncoated graphite agglomerate particles as defined may exhibit slightly lower capacity retention (calculated from the 2^{nd} cycle), in comparison with their 1-step HT and 2-step HT carbon-coated counterparts. In some embodiments, the capacity retention of such electrodes is 94.4±2.2%, 95.1±0.4%, and 94.5±0.8%, respectively.

Those skilled in the art will appreciate that the type of graphite agglomerate particles used may impact the properties of the resulting electrodes. For example, the presence of a carbon coating may help contain the volumetric expansion of the graphite agglomerate particles and/or significantly maintain the electronic conductivity of the electrode. Moreover, the carbon coating may decrease the irreversible capacity in each cycle, particularly when the electrode comprises graphite agglomerate particles obtained with the 1-step HT method, which enables a more reversible intercalation, comparable to commercial graphite.

In addition, as the graphite agglomerate particles as defined herein have been heat treated, despite having a relatively large surface area due to the carbonization of the binder, they may yield higher initial Coulombic efficiency compared to the raw material and may exhibit cycling performances comparable to a commercial natural graphite for over 100 cycles. Overall, the carbon-coated graphite agglomerate particles as defined herein generally exhibit improved electrochemical and/or mechanical properties, especially when obtained through 1-step HT.

The electrodes can be prepared by any compatible method known in the art. For example, a slurry containing the electrode material as defined herein can be prepared by mixing all components described above. Any known compatible mixing method is contemplated. In some embodiments of interest, about 6.5 wt. % of a mixture of CMC and SBR (e.g., in a mass ratio of about 30:70) as the binder, about 92.5 wt. % of graphite agglomerate particles as defined herein (carbon-coated or not) as the active material, and about 1 wt. % of carbon black (e.g., Super C65) as the electronically conductive material can be mixed (e.g., by resonant acoustic mixer at an acceleration of about 50 G for about 15 minutes). The slurry thus obtained can then be coated on a current collector (e.g., an aluminum or a copper foil). Any compatible coating method is contemplated. For example, the coating step may be performed by at least one of a doctor blade coating method, a comma coating method, a reverse-comma coating method, a printing method such as gravure coating, or a slot-die coating method. In some embodiments of interest, the coating step is performed by a doctor blade coating method. In some embodiments of interest, the slurry can be coated on a copper foil (e.g., 25 μm thick) using a doctor blade film applicator. For example, the blade gap can be set to about 200 μm to obtain a graphite areal mass loading of about 5 mg·cm⁻². The coating can then be dried. In some embodiments, the coating is dried in air at room temperature for about 24 hours. Electrode disks (e.g., 10 mm diameter) can then be subsequently punched out of the electrode thus obtained. It is to be understood that the method described herein is for laboratory scale testing and can be adjusted to commercial scale.

An electrochemical cell comprising an anode, a cathode, and an electrolyte, wherein at least one of the anode and the cathode comprise the electrode material as defined herein is also contemplated. In some embodiment of interest, the anode comprises the electrode material as defined herein.

An electrochemical cell comprising an anode, a cathode, and an electrolyte, wherein at least one of the anode and the cathode is the electrode as defined herein is also contemplated. In some embodiment of interest, the anode is the electrode as defined herein.

The cathode comprises an electrochemically active material which may be any known electrochemically active material, and which may be selected for its electrochemical compatibility with the various elements of the electrochemical cell as defined herein. For example, the electrochemically active material of the cathode can be selected for its electrochemical compatibility with the material of the anode as defined herein. Non-limiting examples of electrochemically active cathode materials include metal oxides (e.g., lithium metal oxides), metal phosphates (e.g., lithium metal phosphates), titanates (e.g., lithium titanates), metal fluorophosphates (e.g., lithium metal fluorophosphates), metal oxyfluorophosphates (e.g., lithium metal oxyfluorophosphates), metal sulfates (e.g., lithium metal sulfates), metal halides (e.g., lithium metal halides), and a combination of at least two thereof. For example, the metal of the electrochemically active material may be selected from the group consisting of titanium, iron, magnesium, manganese, vanadium, nickel, cobalt, aluminum, chromium, copper, antimony, zirconium, zinc, niobium, and a combination of at least two thereof, when compatible. In some embodiments of interest, the electrochemically active cathode material is a lithium metal oxide or a lithium metal phosphate. More particularly, the electrochemically active cathode material can be selected from lithium cobalt oxide (LiCoO₂), lithium manganese oxide (LiMn₂O₄), lithium iron phosphate (LiFePO₄ or LFP), and lithium nickel manganese cobalt oxide (LiNiMnCoO₂ or NMC).

The electrolyte may be selected for its compatibility with the different elements of the electrochemical cell. Any type of compatible electrolyte is contemplated. In some embodiments, the electrolyte is a liquid electrolyte comprising a salt in a solvent. In some other embodiments, the electrolyte is a gel electrolyte comprising a salt in a solvent and optionally a solvating polymer. In some other embodiments, the electrolyte is a solid polymer electrolyte comprising a salt in a solvating polymer. In some other embodiments, the electrolyte comprises an inorganic solid electrolyte material, for example, the electrolyte may be a ceramic-type solid electrolyte. In some other embodiments, the electrolyte is a polymer-ceramic hybrid solid electrolyte.

In some embodiments, the salt, if it is present in the electrolyte, may be an ionic salt, such as a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium difluorophosphate (LiDFP), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃](LiFAP), lithium tetrakis(trifluoroacetoxy)borate Li[B(OCOCF₃)₄](LiTFAB), lithium bis(1,2-benzenediolato(2-)-O,O′)borate Li[B(C₆O₂)₂](LiBBB), lithium difluoro(oxalato)borate (LiBF₂(C₂O₄)) (LiFOB), a salt of formula LiBF₂O₄R^{x} (where R^{x}=C₂₋₄alkyl), and a combination of at least two thereof. In some embodiments of interest, the lithium salt is LiPF₆.

In some embodiments, the solvent, if it is present in the electrolyte, may be a non-aqueous solvent. Non-limiting examples of solvents include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), and dipropyl carbonate (DPC); lactones such as γ-butyrolactone (γ-BL) and γ-valerolactone (γ-VL); acyclic ethers such as 1,2-dimethoxyethane (DME), 1,2-diethoxyethane (DEE), ethoxymethoxyethane (EME), trimethoxymethane, and ethylmonoglyme; cyclic ethers such as tetrahydrofuran, 2-methyltetrahydrofuran, 1,3-dioxolane, and dioxolane derivatives; and other solvents such as dimethylsulfoxide, formamide, acetamide, dimethylformamide, acetonitrile, propylnitrile, nitromethane, phosphoric acid triester, sulfolane, methylsulfolane, propylene carbonate derivatives, and a combination of at least two thereof. In some embodiments of interest, the solvent is a mixture of EC and DMC (50/50; v/v).

In some embodiments, a gel electrolyte or liquid electrolyte as defined above may also impregnate a separator such as a polymer separator or glass microfiber membrane. Examples of separators include, but are not limited to, polyethylene (PE), polypropylene (PP), cellulose, polytetrafluoroethylene (PTFE), polyvinylidene fluoride (PVDF), and polypropylene-polyethylene-polypropylene (PP/PE/PP) separators. For example, the separator can be a Whatman™ grade GF/D glass microfiber membrane.

An electrochemical accumulator comprising at least one electrochemical cell as defined herein is also contemplated. In some embodiment of interest, the electrochemical accumulator is a battery selected from a lithium battery, a lithium-ion battery, a sodium battery, a sodium-ion battery, a magnesium battery, and a magnesium-ion battery. In some embodiments of interest, the battery is a lithium-ion battery.

The application of the graphite agglomerate particles as a battery grade graphite for LIBs is particularly advantageous considering LIBs have become a prominent energy storage solution and an essential tool in modern societies. With three decades in the market, LIB technology has seen remarkable commercial success, and it currently dominates the energy storage market due to its high energy per unit mass, high power-to-weight ratio, and low self-discharge with respect to other types of rechargeable systems such as lead-acid and nickel-metal hydride batteries. The demand for LIBs is expected to further increase in the next years, driven by the popularity of consumer portable electronics and more importantly, by the growing commercialization of electric vehicles and hybrid electric vehicles.

It is worth noting that electrodes do not have to be prepared using only the graphite agglomerate particles as defined herein (e.g., produced by the method as defined herein). For example, the electrodes can be prepared using slurries comprising the graphite agglomerate particles as defined herein (e.g., produced by the method as defined herein) and conventional battery grade graphite.

### Potential Advantages

Certain advantages will be readily understood by those skilled in the art upon reading the present disclosure. Furthermore, in certain embodiments, the method, the graphite agglomerate particles, the electrode material, the electrode, the electrochemical cell, and/or the electrochemical accumulator as defined herein may further present one or more of the following advantages:

The method as defined herein can allow for the revalorization and recycling of graphite fines. For example, the graphite fines can be a by-product from spheroidization of flake natural graphite and can be recycled and revalorized by the method as defined herein.

The structural integrity of the graphite agglomerate particles as defined herein may not be substantially compromised by the calendering process.

The method as defined herein can be relatively simple and/or relatively inexpensive.

The use of a binder and spray drying process can make the method as defined herein readily scalable and/or relatively low-cost.

This method as defined herein can be continuous, low cost, and/or suitable for large-scale production.

The method as defined herein can allow producing spherical-shaped or near-spherical-shaped graphite agglomerate particles with D₅₀ comparable to a commercial battery grade natural graphite.

The graphite agglomerate particles as defined herein can exhibit sufficient mechanical strength to endure the calendering process, which is a standard step in the manufacture of anodes for LIBs.

Despite having a relatively large surface area due to the carbonization of the binder (because of the heat treatment step (iii)), the graphite agglomerate particles as defined herein can yield a higher initial Coulombic efficiency compared to the raw material and/or exhibit cycling performances comparable to that of a commercial natural graphite for over 100 cycles.

The optional surface modification of the graphite agglomerate particles by carbon coating can further improve the electrochemical and/or mechanical properties of the electrode material as defined herein.

The method can allow for the recovery and re-integration of waste or by-product graphite fines into the production chain of battery grade natural graphite and of anodes for LIBs. This could lead to improved waste recycling and/or to increases in productivity and financial gains for any producer of battery grade natural graphite.

The 1-step HT can have a positive effect not only on the electrochemical performances, but also in terms of industrial production feasibility, given that a single step heat treatment in the production chain can translate into an overall more efficient process.

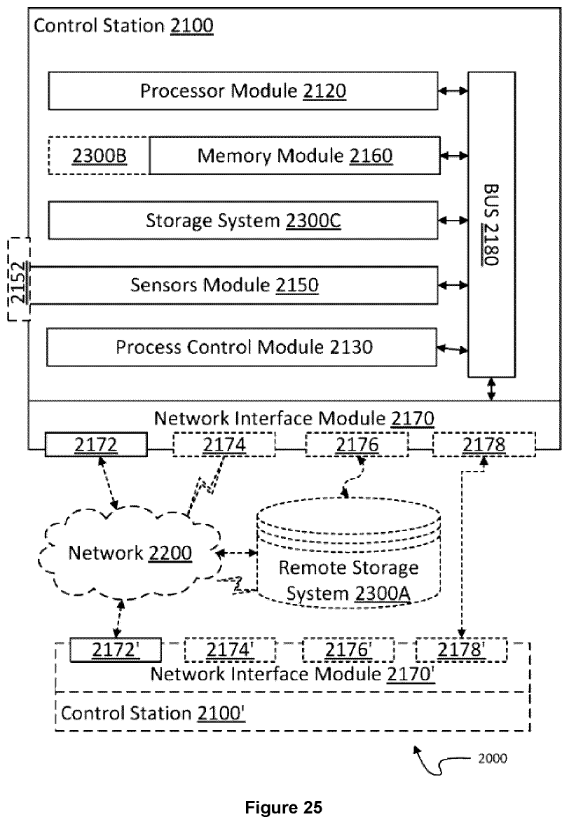

Reference is now made to FIG. 25, which shows a logical modular representation of an exemplary system 2000 comprising a control station 2100. The control station 2100 comprises a memory module 2160, a processor module 2120, a process control module 2130 and a network interface module 2170. The control station 2100 may also include a sensor module 2150.

The system 2000 may comprise a storage system 2300 for storing and accessing long-term (i.e., non-transitory) data and may further log data while the control station 2100 is being used. FIG. 25 shows examples of the storage system 2300 as a distinct database system 2300A, a distinct module 23000 of the control station 2100 or a sub-module 2300B of the memory module 2160 of the control station 2100. The storage system 2300 may be distributed over different systems A, B, C. The storage system 2300 may comprise one or more logical or physical as well as local or remote hard disk drive (or an array thereof). The storage system 2300 may further comprise a local or remote database made accessible to the control station 2100 by a standardized or proprietary interface or via the network interface module 2170.

The network interface module 2170 represents at least one physical interface that can be used to communicate with other network nodes. The network interface module 2170 may be made visible to the other modules of the control station 2100 through one or more logical interfaces. The actual stacks of protocols used by the physical network interface(s) and/or logical network interface(s) 2172-2178 of the network interface module 2170 do not affect the teachings of the present invention.

The processor module 2120 may represent a single processor with one or more processor cores or an array of processors, each comprising one or more processor cores. The memory module 2160 may comprise various types of memory (different standardized or kinds of Random Access Memory modules, memory cards, Read-Only Memory modules, programmable Read-Only Memory, etc.).

A bus 2180 is depicted as an example of means for exchanging data between the different modules of the control station 2100. The teachings presented herein are not affected by the way the different modules exchange information. For instance, the memory module 2160 and the processor module 2120 could be connected by a parallel bus, but could also be connected by a serial connection or involve an intermediate module (not shown) without affecting the teachings of the present invention.

A process control module 2130 provides process-related services to the control station 2100. The process control module 2130 may be used to exchange information with industrial pieces of equipment (not shown) through the network interface module 2140 and/or one or more dedicated interface 2152 of the sensor's module 2150. More specifically, the control station 2100 may be in direct or indirect communication with different devices that are involved in the method for producing graphite agglomerate particles as defined herein. Different control parameters may be computed (e.g., by the process control module 2130 using the processor module 2120) depending on the manner in which the method of producing graphite agglomerate particles as defined herein should be performed. For instance, with concurrent reference to FIG. 2, the control station 2100 may be configured to control completely or partly the operation(s) of one or more of the feed tank (1), the mixer (2), the pump (3), the drying medium heater (4), the pump (5), the atomizer nozzle (6), the drying chamber (7), the dust collector (8), the separator (9), the product collection vessel (10), and the extraction fan (11) to perform the method for producing graphite agglomerate particles as defined herein. The devices (1) to (11) may further be selectively interconnected to facilitate automation of the method for producing graphite agglomerate particles as defined herein. The interconnecting apparatus may take different forms (conveyor, pipes, vents, etc.) depending on the role of the devices (1) to (11) therein. Furthermore, some of the devices (1) to (11) may not be involved in some of the steps and/or may be involved in one or more additional locations and operated by one or more additional entities. The control station 2100 may further be in communication (e.g., through the network 2000) with another control station 2100′ when the method for producing graphite agglomerate particles is executed at multiple locations and/or when providing more than one control stations is better suited to complete the method for producing graphite agglomerate particles (e.g., large plant; multi-site plan; etc.).

The variants of processor module 2120, memory module 2160, and network interface module 2170 usable in the context of the present invention will be readily apparent to those skilled in the art. Likewise, even though explicit mentions of the process control module 2130, the memory module 2160, the sensor module 2150, and/or the processor module 2120 are not made throughout the description of the present examples, those skilled in the art will readily recognize when such modules are used in conjunction with other modules of the control station 2100 to perform routine as well as innovative elements presented herein.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

### EXAMPLES

The following examples are for illustrative purposes only and should not be construed as further limiting the scope of the invention as contemplated. These examples will be better understood by referring to the accompanying Figures.

Specifically, the graphite agglomerate particles were produced using the method as defined herein. Various parameters of the resulting graphite agglomerate particles and electrodes made therefrom were measured and compared to those of conventional graphite electrodes.

Unless otherwise indicated, all numbers expressing quantities of components, preparation conditions, concentrations, properties, etc. used herein are to be understood as modified in all instances by the term “about”. At the very least, each numerical parameter should be interpreted in the light of the number of the reported significant digits and by applying common rounding techniques. Therefore, unless otherwise indicated, the numerical parameters set forth in the present document are approximations which may vary depending on the desired properties. Notwithstanding the fact that the ranges of numerical values and the parameters defining the scope of the embodiments are approximations, the numerical values presented in the following examples are reported as accurately as possible. However, any numerical value inherently contains certain errors resulting from variations in experiments, test measurements, statistical analyses, etc.

### Example 1: Graphite Agglomerate Particles—Experimental Conditions and Methods

### a) Reagents

Fine natural graphite (f-NG) (carbon content=99.7%, D₅₀≈7 μm) obtained as by-product of the spheroidization of purified natural graphite flakes was used without further purification. The petroleum pitch (ZL 250 M) (RUTGERS Germany GmbH) was used without further purification. Sodium carboxymethyl cellulose (average molecular weight M_{W}≈90,000; degree of substitutions=0.7), lithium foil (thickness 1 mm; 99.9%), and battery grade LP30 (a LiPF₆ solution in EC and DMC with a concentration of 1 M of LiPF₆ in EC/DMC (50/50; v/v) were purchased from Sigma. Citric acid (>99.5%) was purchased from Alfa Aesar. SBR (50% solid content) and Super C65 conductive carbon black were purchased from MTI corporation. PGPT102 natural graphite (battery grade) was purchased from Targray.

b) Agglomeration of f-NG into Spray-Dried Re-Agglomerated Graphite Particles

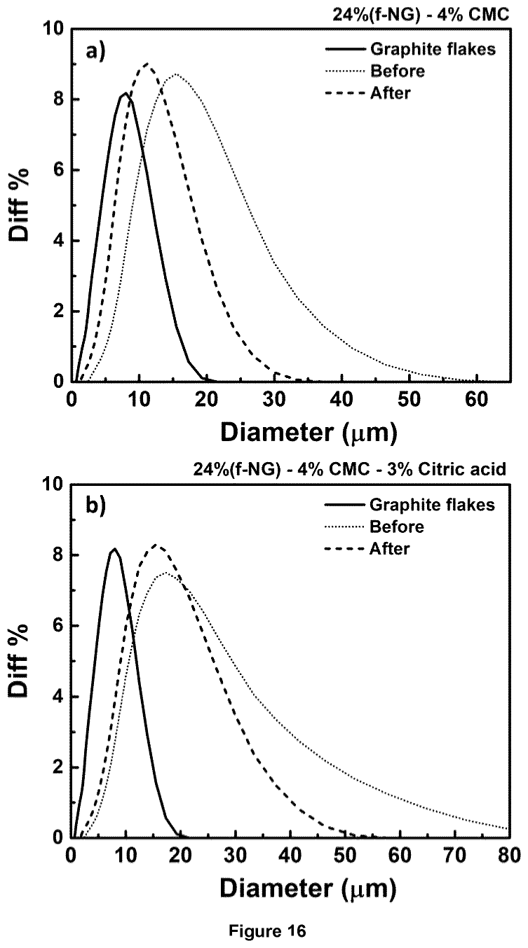

Agglomeration f-NG into spray-dried re-agglomerated graphite particles was achieved using a spray dryer (Pilotech, Mini Spray Dryer YC-015) and using CMC as the binder. Preliminary spray drying studies were performed to evaluate the effect of f-NG/CMC mass ratio and f-NG content, as well as parameters, such as feed rate, inlet temperature, and air blow rate on the particle size of the resulting product. The results of these studies are reported in Tables 4 to 8. Briefly, slurries containing selected f-NG:CMC ratios and content of f-NG were prepared, and after graphite agglomeration and subsequent heat treatment of the resulting products, particle size distribution (PSD) analyses were performed to obtain preliminary D₅₀ data. This data was processed through Minitab® software to determine the importance of the various parameters. Through a weighted Pareto chart (FIG. 15), the content of f-NG was identified as the parameter with the greatest effect on the particle size of the resulting agglomerate, followed by the f-NG/CMC mass ratio. Optimal content of f-NG and f-NG:CMC mass ratio were then found to be about 24 wt. % and about 6:1, respectively. Feed rate, inlet temperature, and air blow rate parameters were found to have a more limited effect on the particle size, with optimal values of about 20.3 mL·min⁻¹, about 210° C., and about 2.5 m³·min⁻¹, respectively. Additionally, 3 wt. % citric acid was incorporated into the slurry to enhance the mechanical strength of the spray-dried re-agglomerated graphite particles and the subsequent graphite agglomerate particles via cross-linking reaction with CMC. The effect of citric acid was evaluated by measuring the PSD of the graphite agglomerate particles before and after a ball milling step (FIG. 16), which was performed using a 15 mL IKA® disperser tube with 3 glass balls driven by an IKA® ULTRA-TURRAX® Tube Drive for about 30 minutes. The PSD analyses suggested more severe particle fracture during ball milling for the graphite agglomerate particles without citric acid, as their D₅₀ underwent larger decrease in comparison with the graphite agglomerate particles with 3 wt. % of citric acid. Therefore, in some examples, the final composition of the slurry for achieving the desired D₅₀ comprised about 4 wt. % of CMC, about 3 wt. % of citric acid, about 24 wt. % of f-NG, and about 69 wt. % of water. All the slurries for spray drying described in this section were mixed by resonant acoustic mixer (RAM, ResoDyn LabRam) at an acceleration of about 50 G for about 30 minutes.

### c) Spray Drying Study

The findings through the preliminary spray drying study are reported in Tables 1 to 5. The experiments revealed that the granule size increases with decreasing f-NG:CMC ratio, although the latter is ultimately limited by the viscosity of the slurry. As mentioned, the optimal f-NG:CMC mass ratio was found to be about 6:1. The content of f-NG also plays an important role in the granule size, as the D₅₀ of the resulting agglomerate increases with the amount of raw graphite. Optimal content of f-NG was determined to be about 24 wt. %, while the feed rate, inlet temperature, and air blow rate parameters were found to have a more limited effect on the particle size, with optimal values of about 20.3 mL·min⁻¹, about 210° C., and about 2.5 m³·min⁻¹, respectively.

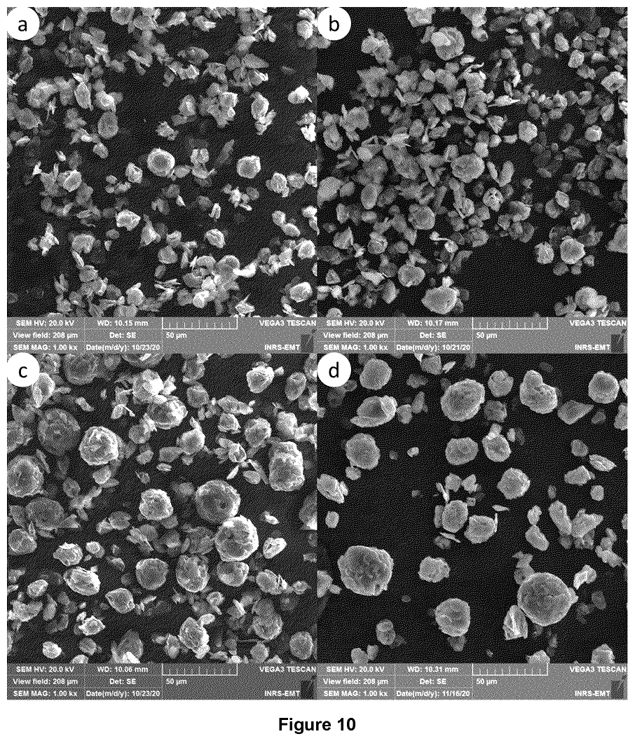

TABLE 1
Impact of the f-NG content

| f-NG content | 14 wt. % | 21 wt. % | 28 wt. % | 33 wt. % |
|---|---|---|---|---|
| f-NG:CMC mass ratio | 10:1 | 10:1 | 10:1 | 10:1 |
| Inlet temperature (° C.) | 220 | 220 | 220 | 220 |
| Feeding rate (mL/min) | 9.8 | 9.8 | 9.8 | 9.8 |
| Blow rate (m³/min) | 2.5 | 2.5 | 2.5 | 2.5 |
| D10 (μm) | 4.7 | 5.2 | 5.9 | 5.9 |
| D50 (μm) | 9.6 | 10.7 | 13.0 | 13.0 |
| D90 (μm) | 16.4 | 18.4 | 24.8 | 22 |
| D97(μm) | 20.3 | 22.9 | 31.5 | 26.7 |
| SEM | FIG. 10(a) | FIG. 10(b) | FIG. 10(c) | FIG. 10(d) |

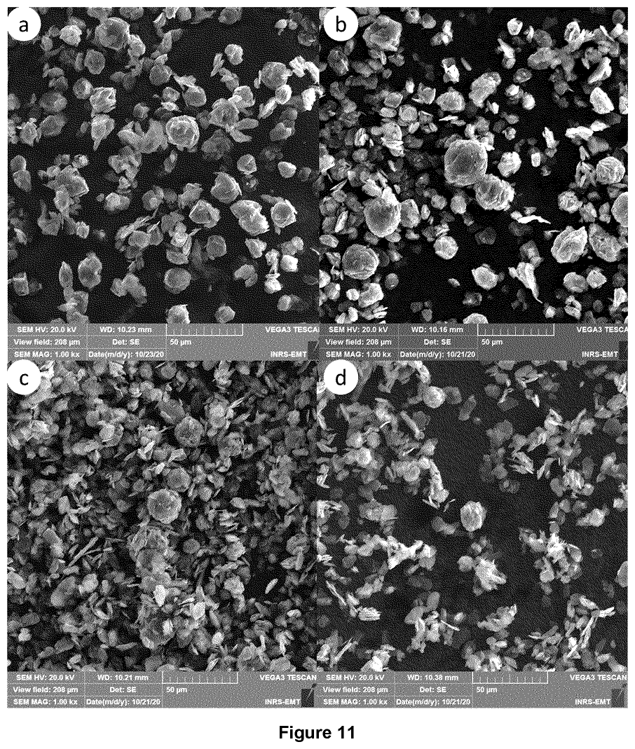

TABLE 2
Impact of the NG:CMC mass ratio

| f-NG:CMC mass ratio | 50:1 | 30:1 | 10:1 | 6:1 |
|---|---|---|---|---|
| f-NG content | 21 wt. % | 21 wt. % | 21 wt. % | 21 wt. % |
| Inlet temperature (° C.) | 220 | 220 | 220 | 220 |
| Feeding rate (mL/min) | 9.8 | 9.8 | 9.8 | 9.8 |
| Blow rate (m³/min) | 2.5 | 2.5 | 2.5 | 2.5 |
| D10 (μm) | 4.1 | 4.3 | 5.2 | 5.7 |
| D50 (μm) | 8.5 | 8.7 | 10.7 | 11.8 |
| D90 (μm) | 15.1 | 14.7 | 18.4 | 21.1 |
| D97(μm) | 18.6 | 17.8 | 22.9 | 26.4 |
| SEM | FIG. 11(a) | FIG. 11(b) | FIG. 11(c) | FIG. 11(d) |

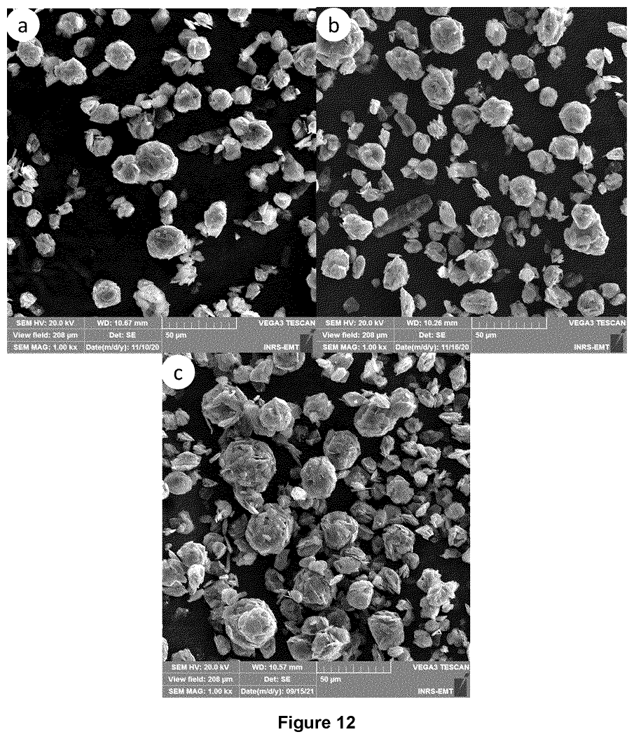

TABLE 3
Impact of the feed rate

| Feed rate (mL/min) | 9.8 | 14.7 | 20.3 |
|---|---|---|---|
| f-NG content | 28 wt. % | 28 wt. % | 28 wt. % |
| f-NG:CMC mass ratio | 10 | 10 | 10 |
| Inlet temperature (° C.) | 210 | 210 | 210 |
| D10 (μm) | 6.5 | 6.6 | 6.8 |
| D50 (μm) | 14.0 | 14.2 | 14.9 |
| D90 (μm) | 25.2 | 25.9 | 28.5 |
| D97(μm) | 31.2 | 32.6 | 36.6 |
| SEM | FIG. 12(a) | FIG. 12(b) | FIG. 12(c) |

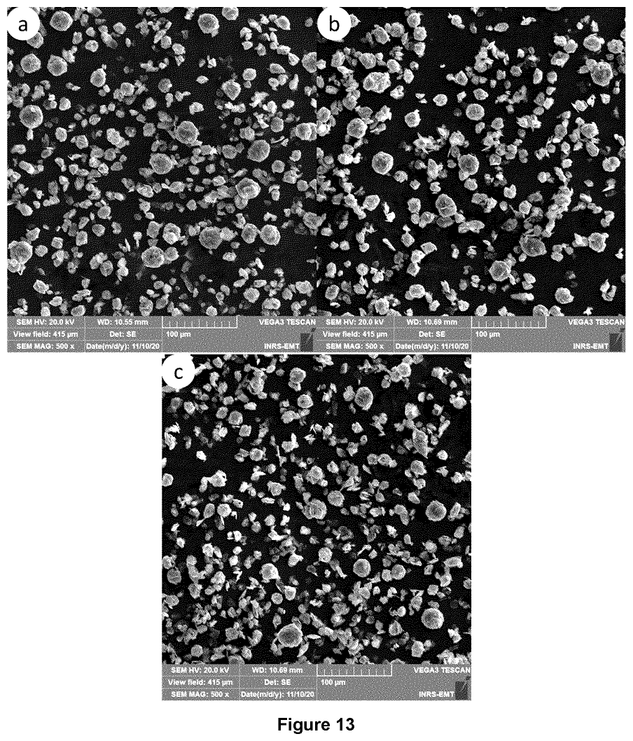

TABLE 4
Impact of the inlet temperature

| Inlet temperature (° C.) | 200 | 210 | 220 |
|---|---|---|---|
| f-NG content | 28 wt. % | 28 wt. % | 28 wt. % |
| f-NG:CMC mass ratio | 10 | 10 | 10 |
| Feed rate (mL/min) | 9.8 | 9.8 | 9,8 |
| D10 (μm) | 6.5 | 6.5 | 5.8 |
| D50 (μm) | 13.4 | 14.0 | 12.5 |
| D90 (μm) | 23.8 | 25.2 | 23.2 |
| D97(μm) | 29.7 | 31.2 | 29.2 |
| SEM | FIG. 13(a) | FIG. 13(b) | FIG. 13(c) |

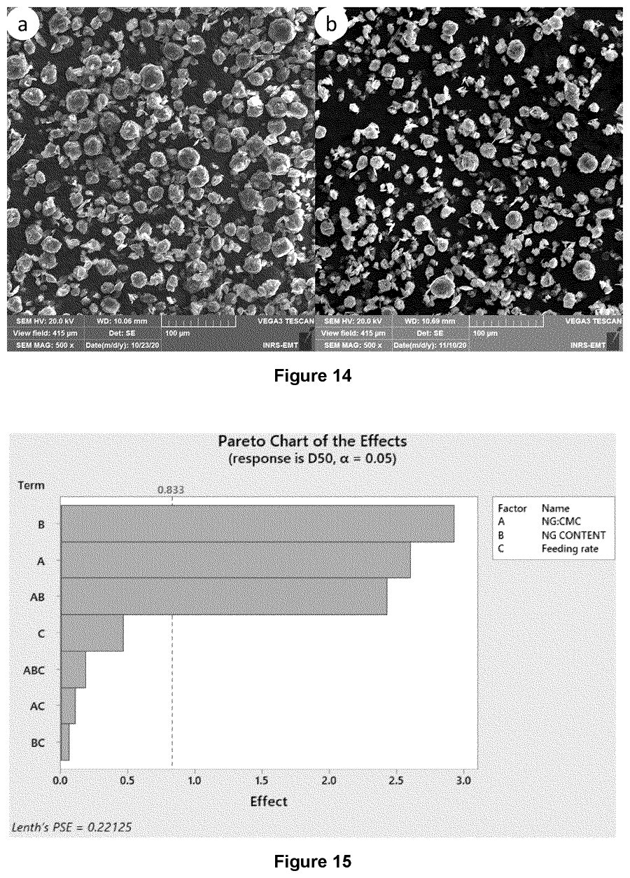

TABLE 5
Impact of the air blow rate

| Air blow rate (m³/min) | 2.5 | 2.0 |
|---|---|---|
| f-NG content | 28 wt. % | 28 wt. % |
| f-NG:CMC mass ratio | 10 | 10 |
| Inlet temperature (° C.) | 220 | 220 |
| Feeding rate (mL/min) | 9.8 | 9.8 |
| D10 (μm) | 5.9 | 5.8 |
| D50 (μm) | 13.0 | 12.5 |
| D90 (μm) | 24.8 | 23.2 |
| D97(μm) | 31.5 | 29.2 |
| SEM | FIG. 14(a) | FIG. 14(b) |

### d) Heat Treatment

Spray-dried powders (i.e., the spray-dried re-agglomerated graphite particles) were subjected to heat treatment in a tube furnace (Thermo Scientific™; Thermolyne™ F21125) under an inert Ar flow. The heat treatment comprises ramp heating from room temperature to about 400° C. (2.00° C./min ramp), isothermal heating at about 400° C. for about 2 hours, followed by a second ramp heating from about 400° C. to about 900° C. (2.00° C./min ramp), and a isothermal heating at about 900° C. for about 2 hours. The CMC/citric acid mass loss due to carbonization during heat treatment was about 80%, which accounts for about 18% of the total heat-treated mass. The carbonized powders were sieved with an ultrasonic sieve (GilSonic AutoSiever™ Sonic Sifter; GA-6) using a stainless-steel mesh with 45 μm openings. The fraction of eliminated particles was about 10 wt. %.

### e) Pitch Coating

Pitch-coated graphite agglomerate particles were obtained through a dry method consisting of mixing spray-dried re-agglomerated graphite particles with coal tar pitch (ZL 250M) (9:1 w/w ratio) using a resonant acoustic mixer (at an acceleration of about 50 G for about 15 minutes), followed by heat treatment for the thermal decomposition of the coal tar pitch. The heat treatment profile consisted of a single temperature ramp at 2.00° C./min from room temperature to about 1000° C. under an inert Ar flow, followed by isothermal heating at about 1000° C. for about 30 minutes. Binder carbonization and pitch coating were thus performed in a single step (referred as 1-step HT hereafter). The CMC/citric acid/Pitch mass loss due to decomposition during heat treatment was about 69%, which accounts for about 21% of the total heat-treated mass. For comparison purposes, an alternative strategy was evaluated, in which graphite agglomerate particles was mixed with coal tar pitch, and then, a second heat treatment for pitch coating was performed (2-step HT). In this case, the pitch mass loss due to carbonization was about 47% (about 4.7% of total heat-treated mass). Pitch-coated particles were sieved as described above. The fraction of eliminated particles was about 15 wt. %.

### f) Material Characterization

The morphology of the uncoated and pitch-coated graphite agglomerate particles was characterized by SEM using a TESCAN VEGA3 instrument, while cross-section images of individual agglomerate particles were obtained by focused ion beam (FIB)-SEM using a TESCAN LYRA3 instrument with a Ga ion source FIB. Post-mortem SEM top view images of the electrodes after 200 cycles were acquired in conjunction with a vacuum transfer chamber to avoid contact of the sample with air. PSD of all materials was measured with a Bettersizer ST laser particle analyzer after dispersing the powders in water. Their crystalline structure was determined by XRD using a Bruker D8 Advance diffractometer equipped with a Cu Kα source (λ=0.15406 nm; 40 kV; 40 mA). All diffractograms were acquired in continuous scan mode with 2θ angular step size of 0.02° and acquisition time of 2 seconds per step. Tap density was measured with a Quantachrome Dual Autotap instrument. Specific surface area of the samples was determined by Brunauer-Emmet-Teller (BET) theory from N₂ adsorption isotherms using a TriStar II Plus Micromeritics™ analyzer.

### g) Calculation of Porosity of Graphite Electrodes

The graphite-based electrode in this study contains active material (graphite), carbon black (Super C65), and binders (CMC and SBR).

Assuming an electrode with no pore, the true or theoretical density (ρₜₕₑₒ) of the electrode was calculated from the mass fractions ρ_{m,i} and the true densities ρᵢ of the individual electrode components according to the formula:

$$\frac{1}{{ρ}_{theo}} = {φ}_{m , graphite} \times \frac{1}{{ρ}_{active}} + {φ}_{m , C65} \times \frac{1}{{ρ}_{C65}} + {φ}_{m , CMC} \times \frac{1}{{ρ}_{CMC}} + {φ}_{m , SBR} \times \frac{1}{{ρ}_{SBR}}$$

The ρₜₕₑₒ of the graphite-based electrodes was estimated at 1.99 with ρ_{graphite}=2.12 and φ_{m,graphite}=92.5%, ρ_{C65}=1.6 and φ_{m,C65}=1%, ρ_{CMC}=1.59 and φ_{m,CMC}=1.95%, and ρ_{SBR}=0.94 and ω_{m,SBR}=4.55%

The porosity (P) of the electrodes was then estimated using the formula:

$$P ( \% ) = ( 1 - \frac{{ρ}_{meas}}{{ρ}_{theo}} ) \times 100$$

where ρₘₑₐₛ is the measured density of electrodes calculated from their measured weight and thickness (excluding the Cu current collector).

### h) Electrode Preparation and Cell Assembly

Slurries containing about 6.5 wt. % of CMC SBR (30:70 mass ratio) as the binder, about 92.5 wt. % of graphite agglomerate particles (pitch-coated or not) as the active material, and about 1 wt. % carbon black Super C65 as the electronically conductive material were mixed using a resonant acoustic mixer at an acceleration of about 50 G for about 15 minutes. The slurries were coated on copper foil (25 μm thick) using a doctor blade film applicator, with a blade gap set to 200 μm to obtain a graphite areal mass loading of about 5 mg·cm⁻². The coatings were dried in air at room temperature for about 24 hours, and electrode disks of 10 mm diameter were subsequently punched out of the dry-coated Cu foil. To study the effect of the porosity and density of the coating on the electrochemical performances, electrodes were calendered using a rolling cylinder press (MSK-HRP-MR100DC, Zhengzhou CY Scientific Instruments). Electrode thickness before and after compaction was measured at the center of each disk with a digital micrometer (Mitutoyo, 293-240-30, 1 μm resolution under the assumption that the Cu current collector is not deformed (as confirmed from cross-section SEM images of the electrodes). All electrodes were dried under vacuum at a temperature of about 100° C. for about 2 hours prior to utilization. The working electrodes were mounted in Swagelok® type cells in a two-electrode configuration, facing a 10 mm diameter lithium metal electrode acting as both reference and counter electrodes. The graphite and lithium electrodes were separated by a borosilicate glass-fiber (Whatman GF/D) membrane, soaked in about 350 μL of LP30 electrolyte, and the ensemble was compressed by a spring on the lithium side to ensure adequate contact. The cells were assembled in Ar-filled glove box (H₂O and 02 concentration≤0.5 ppm) and tightened at about 50 Nm torque.

### i) Electrode Cycling

The graphite electrodes were cycled using a Neware BTS4000 series Battery Testing System at room temperature in galvanostatic mode between 10 mV and 1 V vs Li/Li⁺. Cells rested at the open-circuit voltage for 1 hour prior to cycling and were allowed to rest for 1 second and 35 seconds after each discharge and charge, respectively. A C-rate of C/20 was applied (1 C=372 mA g⁻¹ of graphite) for the first two cycles, while all subsequent cycles were performed at C/9. Rate capability tests were also carried out varying the charge (delithiation) C-rate from C/20 to 2 C whereas the discharge C-rate was fixed at C/10. All electrodes were evaluated in triplicate and results were compared to PGPT102 commercial graphite. The capacities were expressed in mAh per gram of graphite and were averaged from the triplicate cycling tests.

### Example 2: Graphite Agglomerate Particles—Characterization

### a) Physicochemical Characterization

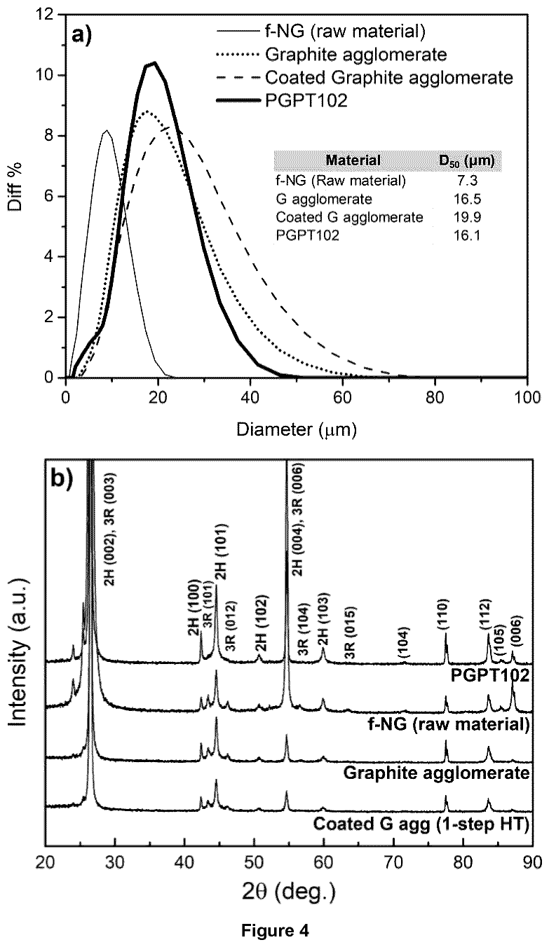

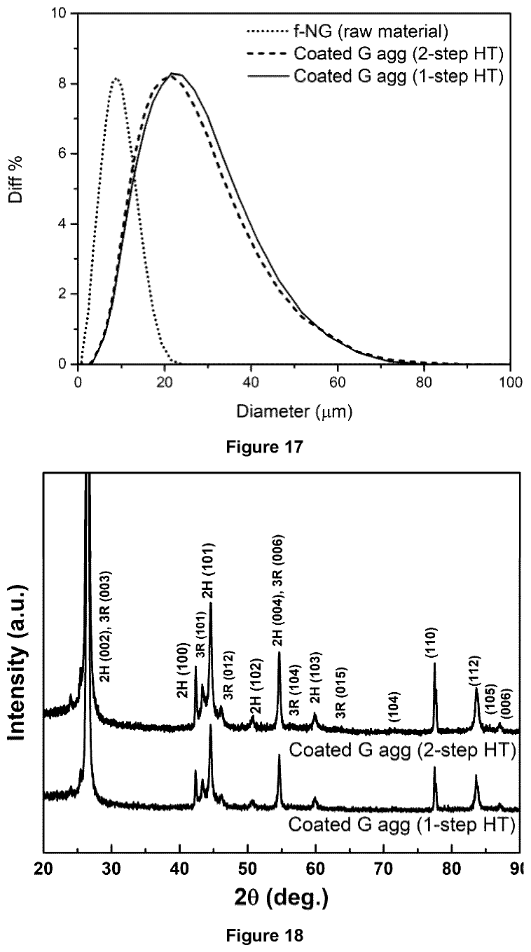

FIG. 4a shows the PSD curves obtained for f-NG raw material, graphite agglomerate particles, and pitch-coated graphite agglomerate particles obtained through 1-step HT, while PGPT102 commercial graphite is included as reference material. The analysis confirmed the successful flake graphite agglomeration, as the D₅₀ value increased from about 7.3 μm to about 16.5 μm after spray drying. Moreover, the resulting graphite agglomerate particles exhibited a PSD comparable to that of PGPT102 graphite (D₅₀=about 16.1 μm), which validates the slurry composition and spray drying parameters. On the other hand, slightly larger PSD, with D₅₀=about 19.9 μm was obtained for the pitch-coated (1-step HT) sample, due to additional pitch-assisted re-agglomeration of graphite particles. Similar PSD (D₅₀=about 19.6) was obtained for pitch-coated graphite agglomerate particles through 2-step HT (FIG. 17).

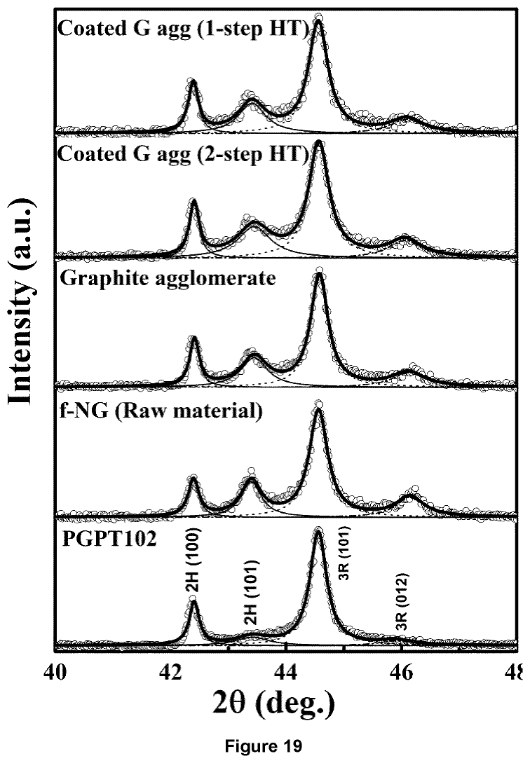

The XRD patterns of all the samples are shown in FIG. 4b. The XRD diffractogram of PGPT102 commercial graphite shows peaks of graphite with hexagonal 2H structure in an ABAB stacking sequence (JCPDS Card, No. 41-1487), including (002), (100), (101), (004) and (110) planes at 2θ=26.4°, 42.3°, 44.6°, 54.6° and 77.5°, respectively. However, for the f-NG raw material and derived graphite agglomerate particles, signals ascribed to graphite with rhombohedral 3R structure are also observed in addition to the 2H structure peaks. The peaks at 2θ=43.4°, 46.1°, 56.5° and 63.4 are indexed to (101), (012), (104) and (015) planes of rhombohedral 3R graphite (JCPDS Card, No. 26-1079), respectively, in which graphene layers are stacked in ABCABC arrangement. This indicates that the graphite agglomerate particles are composed of graphite with both 2H and 3R phases, and that they substantially retain the crystalline structure of the raw material. XRD difractograms of pitch-coated graphite agglomerate particles obtained through 1-step HT and 2-step HT are substantially identical (FIG. 18). To determine the relative concentrations of 2H and 3R phases in the samples, the A_{3R(101)}/A_{2H(101)} ratio was calculated using the areas under the peaks 3R(101) and 2H(101) from the deconvolution of (101) peaks in the 42° to 47° range, as shown in FIG. 19. A_{3R(101)}/A_{2H(101)} values for PGPT102, f-NG, graphite agglomerate particles, 1-step HT and 2-step HT pitch-coated graphite agglomerate particles were 0.15, 0.37, 0.41, 0.46, and 0.40, respectively. As anticipated from the XRD diffractograms, PGPT102 has the least amount of rhombohedral 3R structured, followed by f-NG raw material. The higher content of 3R phase graphite in the uncoated and pitch-coated graphite agglomerate particle samples is not surprising, since carbonization of CMC/citric acid binder and coal tar pitch in these materials lead to the formation of amorphous/disordered carbon. Furthermore, the intensity of (002) and (004) peaks of the uncoated and pitch-coated graphite agglomerate particles decreased relative to the PGPT102 and f-NG samples, which is also consequence of their higher disordered carbon content. The interlayer distances d₀₀₂ and d₁₀₀ of all samples were 0.336 nm and 0.213 nm, respectively, which are consistent with the values of crystalline graphite.

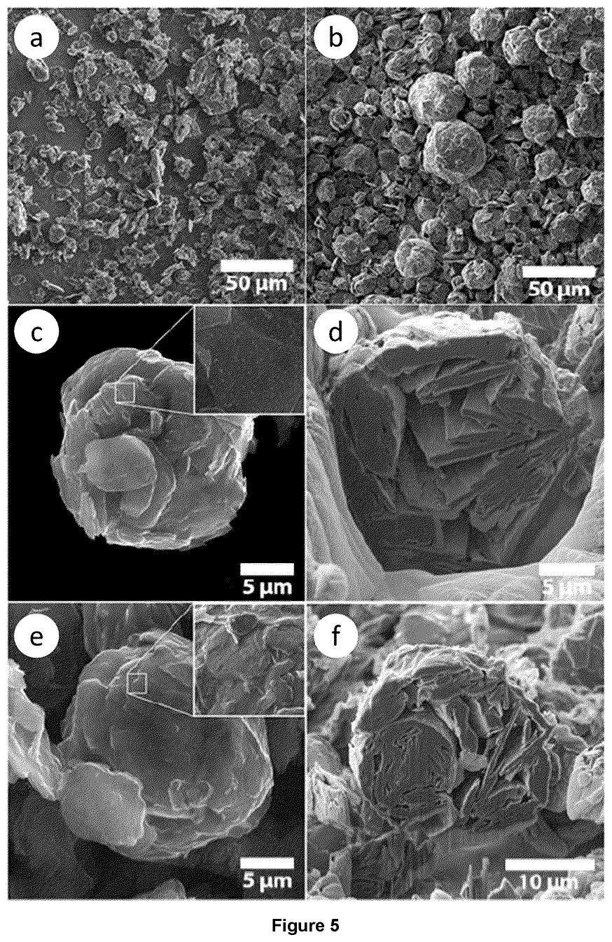

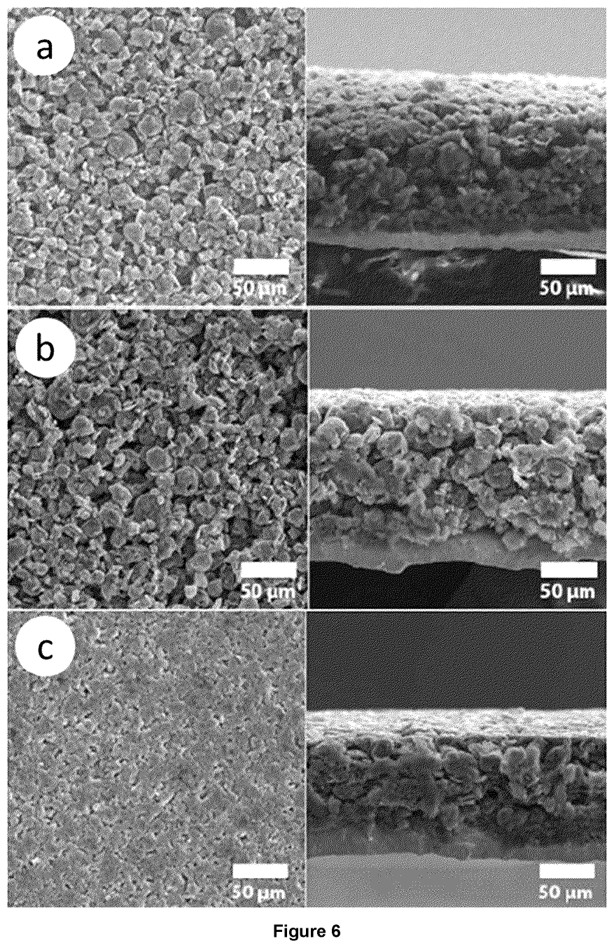

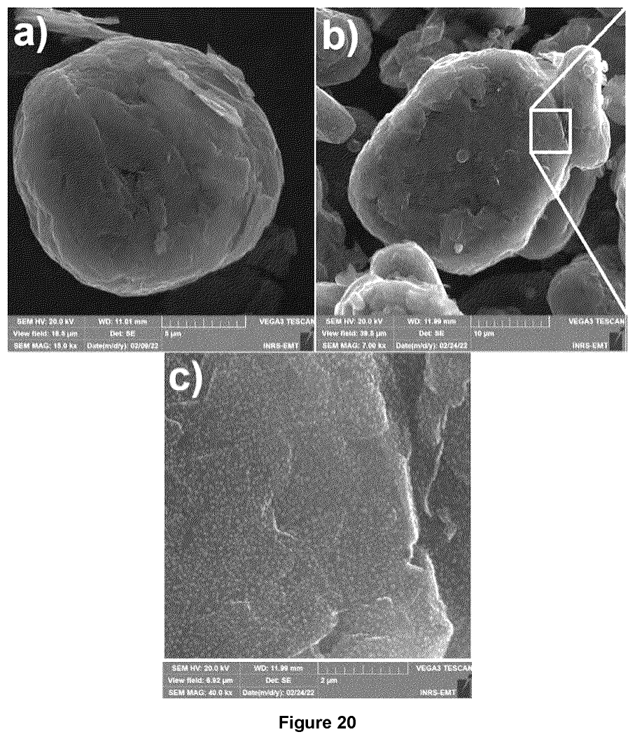

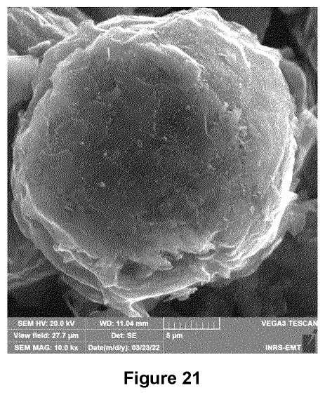

An SEM image of the as-received f-NG raw material is presented in FIG. 5a, in which graphite flakes of distinctly different shapes are observed. In contrast, after flake graphite agglomeration by spray drying and subsequent heat treatment, particles with considerably more homogeneous appearance and quasi-spherical morphology were obtained, as shown in FIG. 5b. An SEM image of a single agglomerated particle is shown in FIG. 5c, where well defined edges from the flakes conforming the agglomerate are observed. Upon a higher magnification analysis, nano-grains of about 20 to about 200 nm in diameter, displayed in the inset of FIG. 5c, were observed atop practically all the agglomerated particle's surface. It has been reported that carbonization of CMC and citric acid may lead to the formation of nano- and micro-sized grains and spheres. To investigate the origin of these features, PGPT102 commercial graphite was subjected to spray drying and heat treatment under the same conditions as the f-NG raw material. SEM images of the obtained powder (FIG. 20) show the same type of nano-grains on the PGPT102 surface as those observed on the graphite agglomerate particles, therefore confirming their nature as a form of carbon resulting from the CMC and citric acid carbonization. On the other hand, the pitch-coated graphite agglomerate particles obtained through 1-step HT (FIG. 5e) exhibited a smoother surface compared to its non-coated counterpart, while following the overall shape of the agglomerate, which is the expected effect of pitch coating. However, a closer inspection of the particle surface (inset of FIG. 5e) revealed that the presence of nano-grains, products of CMC and citric acid carbonization, had been substantially diminished by the pitch coating. Interestingly, the nano-grains are still observed on the surface of the pitch-coated particles obtained through 2-step HT (FIG. 21), which suggests that the absence of these features is due to more than simply a coating effect. Given that the carbonization of CMC/citric acid and thermal decomposition of pitch are performed concurrently in the material obtained in 1-step HT, the formation of nano-grains might be altogether mitigated by side-reactions in the presence of pitch. The nature of the interactions between CMC/citric acid and pitch during heat treatment remains to be investigated. The cross-section imaging by FIB-SEM of uncoated and pitch-coated graphite agglomerate particles, shown in FIGS. 5d and 5f, respectively, revealed voids within the materials, resulting from the folding of graphite flakes of irregular sizes and shapes that conform the agglomerates. The cavities in the agglomerate particles are most likely the reason for their low tap density, in comparison with PGPT102 commercial graphite. Specifically, tap densities of uncoated and pitch-coated graphite agglomerate (1-step HT and 2-step HT) particles are about 0.471 g·cm⁻³, about 0.450 g·cm⁻³, and about 0.444 g·cm⁻³, respectively, which is about 2.3 times lower than the tap density of PGPT102 commercial graphite (1.070 g·cm⁻³). The similarities in inner structure and tap density between uncoated and pitch-coated graphite particles suggest that the effect of the pitch is limited to the surface of the agglomerate.

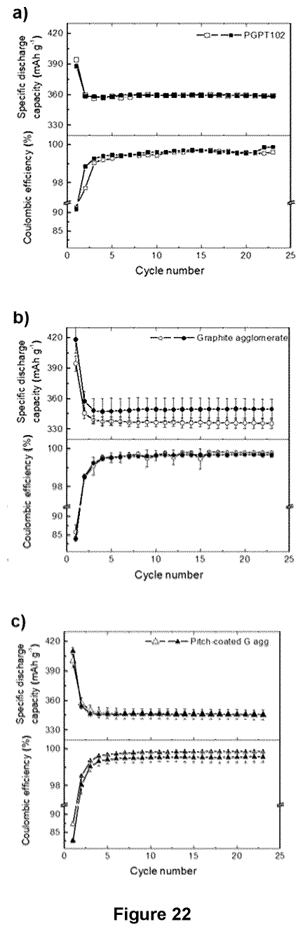

FIG. 22 shows the N₂ adsorption isotherms of the samples, while the BET-specific surface area and micropore area calculated from the adsorption isotherms are reported in Table 6. The analyses revealed that the BET surface area of the graphite agglomerated particles is higher than that of the raw f-NG, which is opposed to the expected outcome. The increase in specific surface area after agglomeration can be the result of the carbonization of CMC/citric acid binder, which formed microporosity in the sample, as evidenced in the t-plot micropore area reported in Table 6. This was confirmed by the surface area analysis of the PGPT102 commercial graphite that was subjected to spray drying and heat treatment. After processing, the specific area of PGPT102 increased from about 2.1 m²·g⁻¹ to about 7.8 m²·g⁻¹, while the micropore area increased from about 0.07 m²·g⁻¹ to about 5.1 m²·g⁻¹. On the other hand, pitch coating (1-step HT and 2-step HT) allowed to decrease the surface area of the graphite agglomerate particles due to the coverage of pores <10 nm, which is the desired effect of the surface modification by pitch.

TABLE 6
BET-specific surface area and micropore area calculated
from the N₂ adsorption isotherms

| | BET Surface | t-Plot Micropore |
|---|---|---|
| | Area | Area |
| Material | (m² · g⁻¹) | (m² · g⁻¹) |
| Fine graphite (raw material) | 11.4 | 0.4 |
| Graphite agglomerate particles | 15.4 | 7.2 |
| Pitch-coated graphite | 9.2 | 4.7 |
| agglomerate particles (2-step HT) | | |
| Pitch-coated graphite | 9.4 | 6.1 |
| agglomerate particles (1 step HT) | | |
| PGPT102 | 2.1 | 0.1 |
| PGPT102 (SD + HT) | 7.8 | 5.1 |

HT = heat treatment,
SD = spray drying

### b) Electrode Morphology

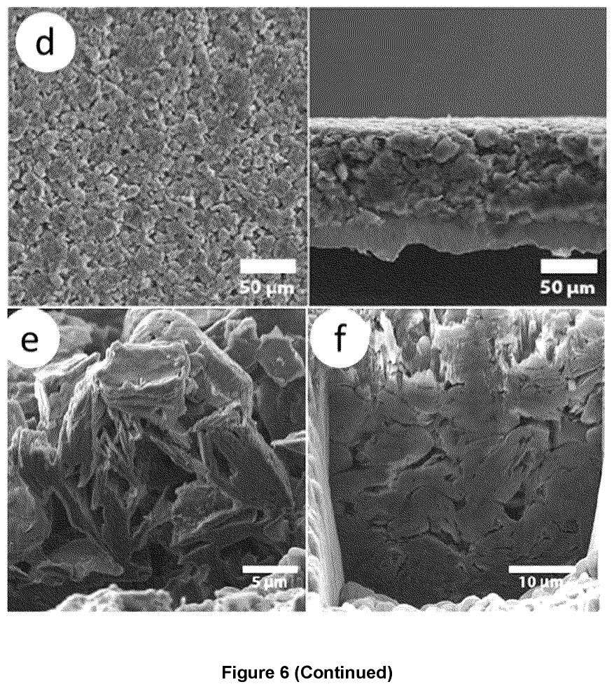

To evaluate the behavior of the uncoated and pitch-coated graphite agglomerate particles after compaction, electrodes were calendered and compared to their non-calendered counterparts. Top and cross-section SEM images of non-calendered graphite agglomerate and pitch-coated graphite agglomerate (1-step HT) electrodes, presented in FIGS. 6a and 6b, respectively, show a coating thickness of about 100 μm. The areal mass loading of the electrodes is 5.1±0.1 mg·cm⁻², with an electrode (coating) density of 0.63±0.01 g·cm⁻³, which results in a porosity of about 70%. SEM images of graphite agglomerate and coated graphite agglomerate electrodes after compaction are shown in FIGS. 6c and 6d, respectively. The thickness of the calendered electrodes is about 45 μm, which increases the electrode density to 1.32±0.02 g·cm⁻³ while the porosity decreases to about 30%. Electrode top and cross-section images show overall good structural integrity after calendering for both uncoated and pitch-coated graphite materials. However, to further investigate the effect of compaction at agglomerate particle level, FIB-SEM technique was employed to analyse non-calendered and calendered uncoated graphite agglomerate electrodes. The cross-section of an agglomerate particle located at the surface of the non-calendered electrode (FIG. 6e) exhibits the same structural features as its powder form (FIG. 5d), indicating that the material remains practically unchanged after the deposition on the copper foil. On the other hand, the FIB-SEM image of the calendered electrode (FIG. 6f), acquired to a depth of practically all the coating layer, revealed substantial particle deformation and a significant reduction of voids within graphite agglomerate particles. However, despite the considerable morphology changes, no obvious agglomerate fractures are observed, as individual agglomerate particles can still be distinguished. Therefore, the structural integrity of the graphite agglomerate particles is not compromised by the calendering process.

### c) Electrochemical Performances

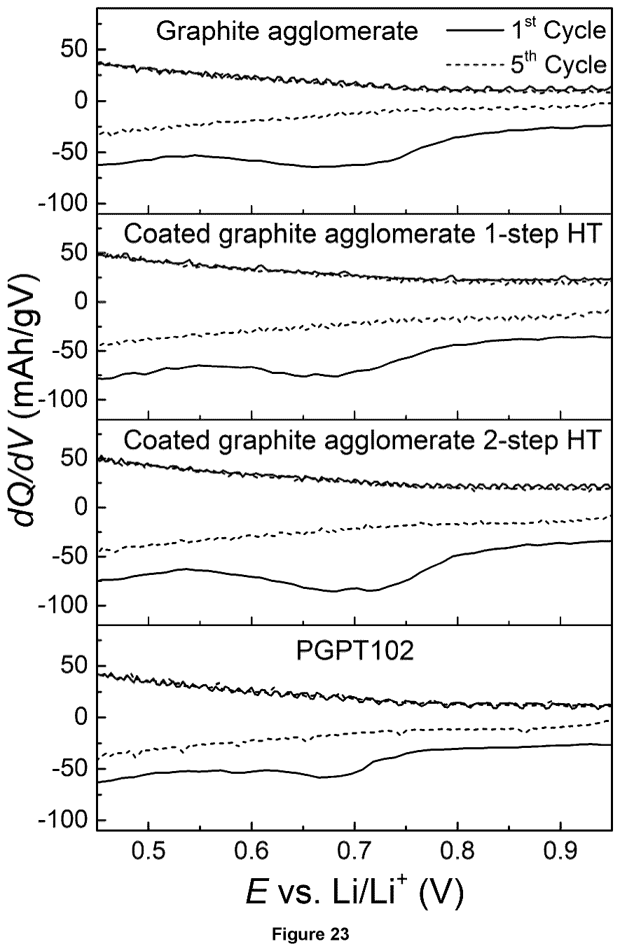

Preliminary short cycling tests were performed to evaluate the impact of calendering on the electrode performances. FIG. 23 compares the specific discharge capacity and Coulombic efficiency with cycling of the uncoated graphite agglomerate, pitch-coated graphite agglomerate, and PGPT102 electrodes before and after calendering. The compaction of the agglomerate-based electrodes does not negatively affect their electrochemical performances, at least at the applied moderate C-rate (C/20 for the 1^{st} cycle and C/9 for subsequent cycles) and for a short cycling period (23 cycles). Therefore, all subsequent cycling tests were performed with calendered electrodes.

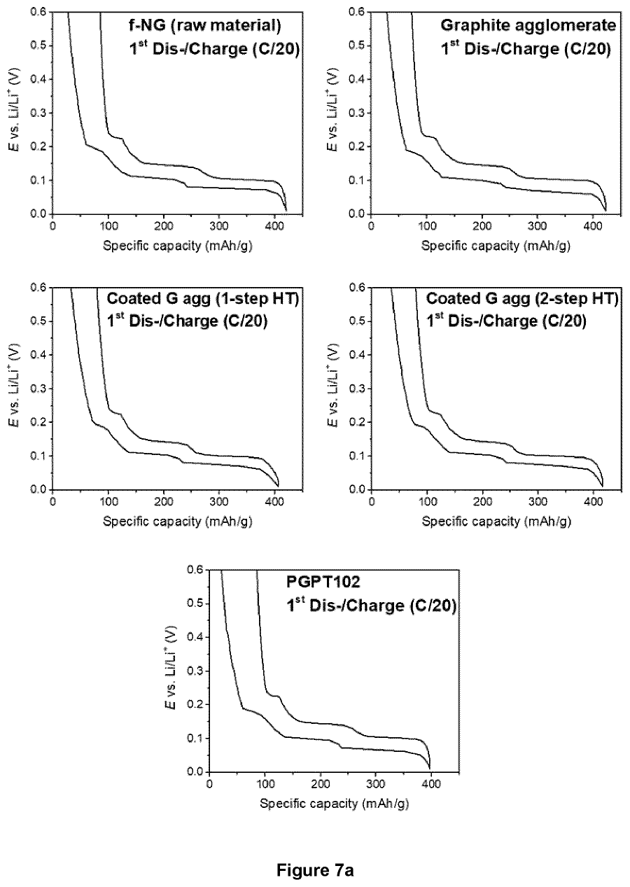

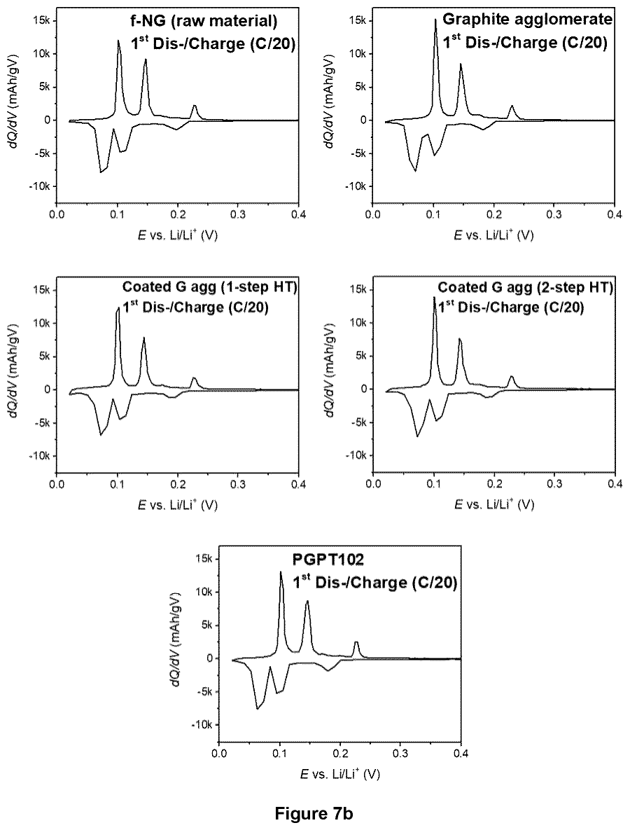

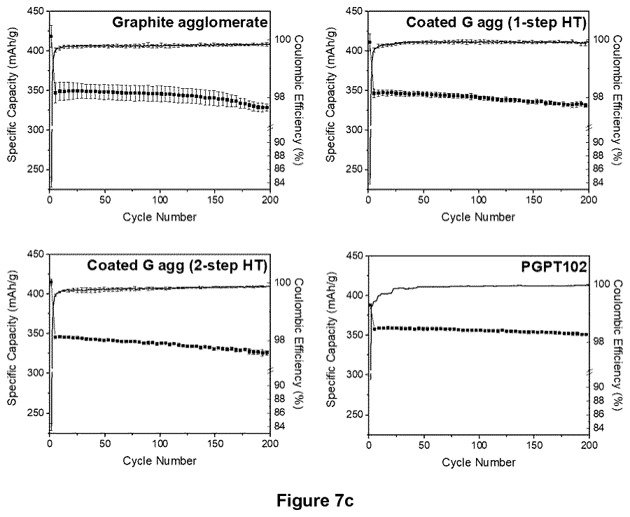

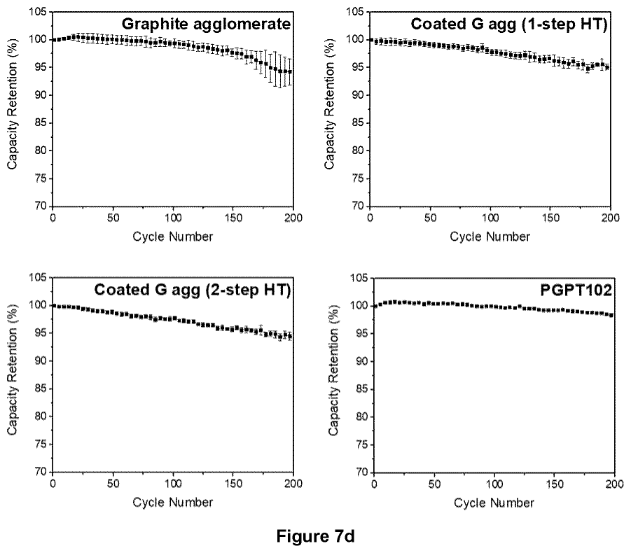

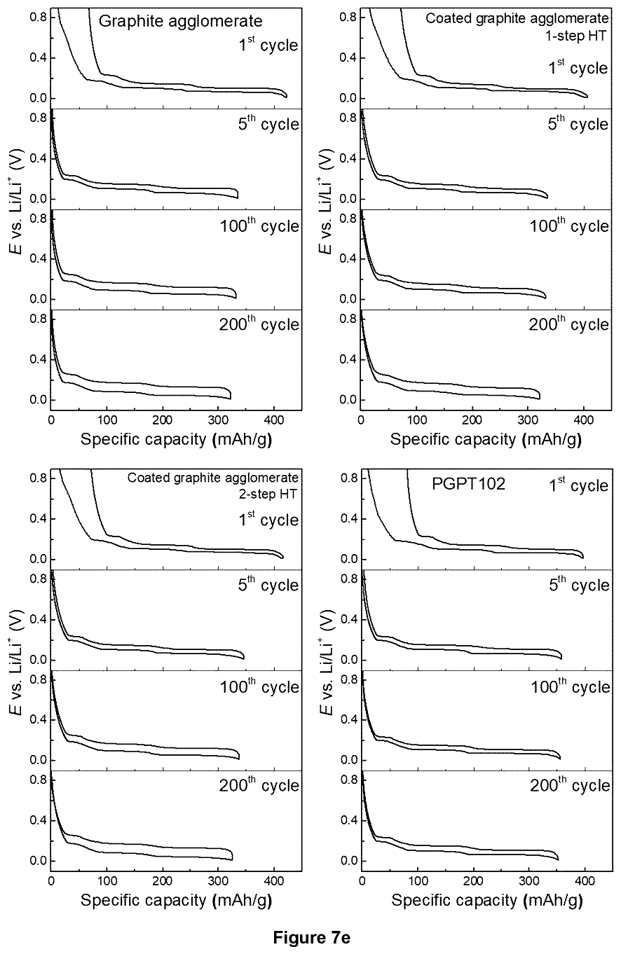

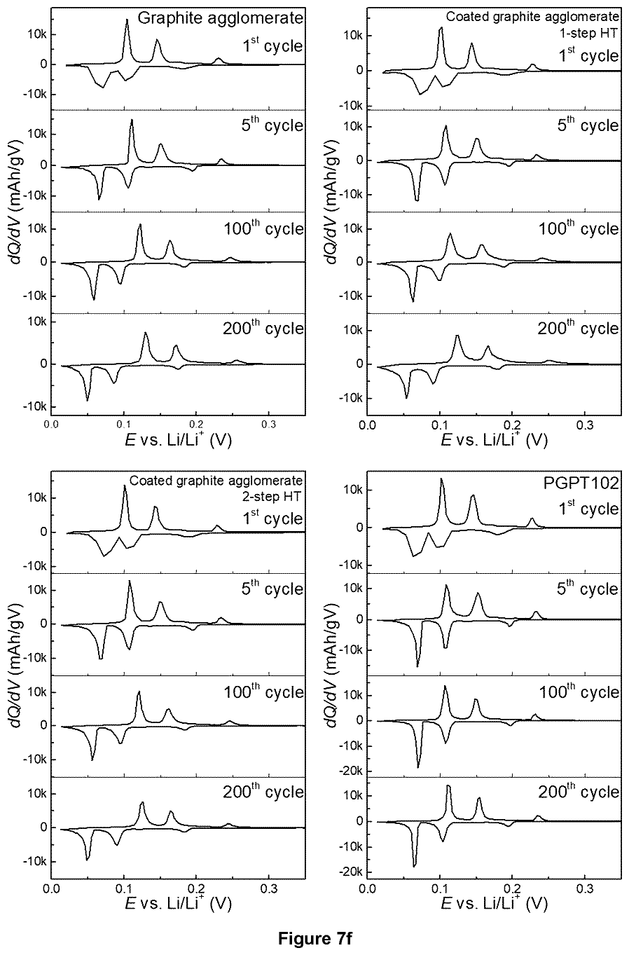

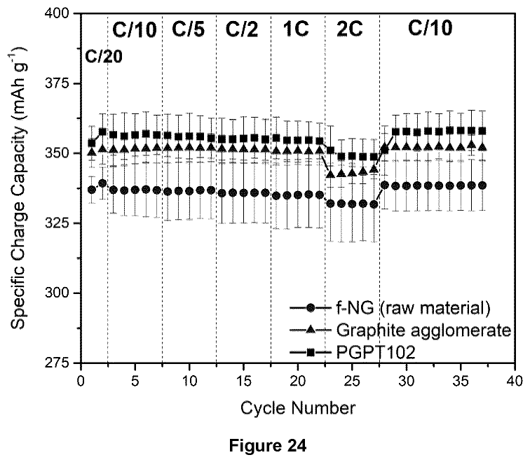

FIG. 7a shows the first cycle discharge/charge curves of the flake graphite, agglomerate-based, and PGPT102 graphite electrodes performed at a C/20 rate. The potential profiles of all electrodes are consistent with the well-known staging mechanism characterized by a sequence of Li⁺ intercalation between graphene layers in the graphite hosts, leading to the formation of LiC₆. All curves exhibit the potential plateaus ascribed to stage formation in graphite, however, these occur at slightly different potentials in each electrode. The potentials where these processes occur can be more clearly observed in the differential capacity plots, shown in FIG. 7b. All electrodes show an irreversible cathodic peak at around 0.7 V vs Li/Li⁺ in the first discharge (FIG. 24), which is ascribed to the formation of the SEI layer. Three reversible cathodic peaks below 0.3 V vs Li/Li⁺, resulting from the intercalation and deintercalation of Li⁺, are observed in all curves. These peaks, found at about 0.18 V, about 0.10 V, and about 0.07 V vs Li/Li⁺ correspond to the diluted stage I to stage IV, stage to III to stage II, and stage II to stage I transitions, respectively. During the first charge step, the corresponding reverse processes give rise to three anodic peaks at about 0.11 V, about 0.15 V, and about 0.23 V vs Li/Li⁺. All processes occur at very similar potential values for the graphite agglomerate and PGPT102 graphite electrodes, which validates the desirable electrochemical behavior of the graphite agglomerate electrode. Interestingly, the cathodic peaks on both pitch-coated graphite agglomerate electrodes are observed at more positive potentials, while anodic peaks appear at slightly lower positive potentials, which could be attributed to better electronic conductivity on these electrodes. Based on triplicate cycling tests for each formulation, first discharge/charge capacities were 416±10/336±5 mAh·g⁻¹, 418±13/351±9 mAh·g⁻¹, 410±4/351±6 mAh·g⁻¹, 415±4/350±2 mAh·g⁻¹, and 388±3/354±6 mAh·g⁻¹, which translate into an initial Coulombic efficiency of 80%, 84%, 86%, 84%, and 91% for f-NG, graphite agglomerate, pitch-coated agglomerate (1-step HT), pitch-coated agglomerate (2-step HT), and PGPT102, respectively. The relatively low initial Coulombic efficiency can be attributed to the formation of the SEI layer, which is an irreversible process. The capacity contribution from the formation of the SEI is more clearly observed in FIG. 7e. Nonetheless, f-NG aside, the Coulombic efficiency of the electrodes rapidly increases and reaches over 99% by the third cycle (Table 7). As anticipated, the f-NG electrode exhibited the lowest initial Coulombic efficiency and its value increased after agglomeration. However, it remains lower than that of the PGPT102 electrode. Moreover, the pitch coating only slightly decreased the irreversible capacity of the graphite agglomerate particles. These unexpected results are likely a consequence of the high surface area and microporosity/mesoporosity (Table 6) generated by the carbonization of CMC and citric acid in the spray-dried powders. It has been informed in various reports that the properties of the starting graphite material influence the degree of the effect of pitch coating. The little effect of pitch coating on the initial Coulombic efficiency suggests that 10 wt. % of pitch cannot effectively cover the entire surface of the graphite agglomerate particles and thus, the pitch coating procedure can be further optimized.

As shown in FIGS. 7c and 7d, the PGPT102 electrodes exhibit overall highest discharge capacity and capacity retention, respectively throughout the 200-cycle test, while graphite agglomerate electrodes show comparable behaviour for about the first 100 cycles. Afterwards, a steady decrease in capacity is observed, which becomes steeper for the uncoated graphite agglomerate electrode, particularly after 150 cycles. This translates into slightly lower capacity retention (calculated from the 2^{nd} cycle) for uncoated graphite agglomerate particles at the end of the test, in comparison with their 1-step HT and 2-step HT pitch-coated counterparts, with 94.4±2.2%, 95.1±0.4%, and 94.5±0.8%, respectively (FIG. 7d). However, the trends seem to indicate better cycling stability for the pitch-coated electrodes.

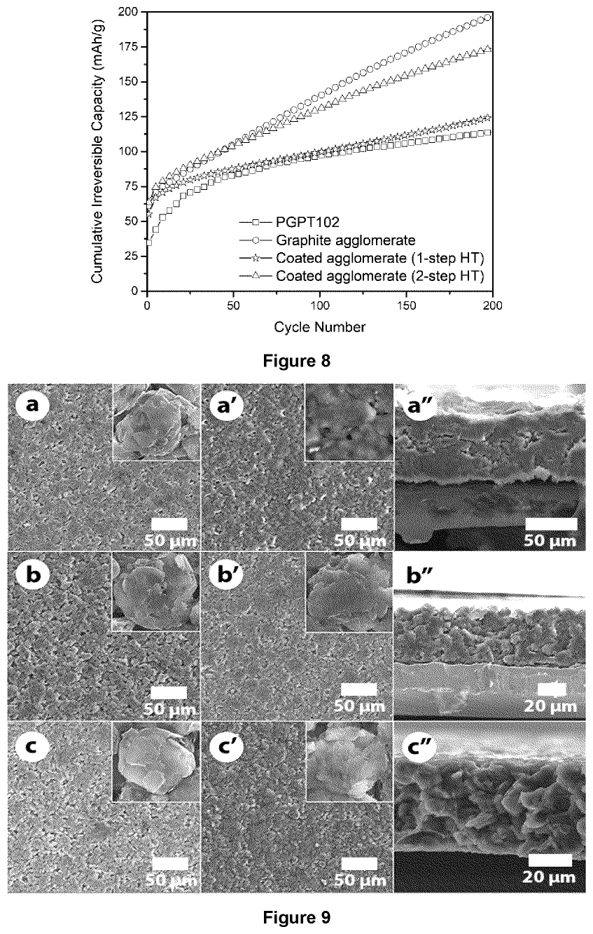

FIG. 7e shows the extent of performance loss for each material by comparing the discharge/charge curves at the 1^{st}, 5^{th}, 100^{th}, and 200^{th} cycles, while the differential capacity plots at selected cycles, shown in FIG. 7f, provide a better insight on the capacity deterioration of the electrodes. In all electrodes, the potentials at which the electrochemical processes occur, change over time, as cathodic peaks undergo potential shifts to lower values, while anodic peaks experience shifts to more positive potentials with cycle progression. However, the changes were minimal in the PGPT102 electrode, as anticipated due to its high cycling stability, while in the agglomerate-based electrodes, the potential shifts were greater, particularly in the uncoated graphite agglomerate. The increasing overpotential of all electrochemical reactions in the agglomerate-based materials is likely result of a decrease in electronic conductivity within the electrodes, while the decrease in capacity suggests a decay of active sites on the electrode. The continuous volume changes caused by the lithiation process may end up fracturing the agglomerate particles and deteriorating the contact between the graphite and the current collector. Although it had initially seemed that the pitch coating had little effect on the electrochemical performances, the differential capacity analysis revealed that it might play a role in the long run, containing the volumetric expansion of the agglomerate particles and preserving the electronic conductivity of the electrode. Moreover, the plot of the cumulative irreversible capacity, displayed in FIG. 8, evidences the favorable effect of the pitch coating, which decreases the irreversible capacity in each cycle, particularly with the material obtained with the 1-step HT method, which enables a more reversible intercalation, comparable to commercial graphite. This is a desirable effect regarding not only electrochemical performances, but also in terms of industrial production feasibility, given that a single heat treatment in the production chain translates into an overall more efficient process. Table 7 compares figures of merit extracted from FIG. 8.

Electrochemical cycling tests with C-rate ranging between C/20 and 2C during the charge (delithiation) step, with the discharge C-rate fixed at C/10, were performed for a rapid evaluation of the charge rate capability of the graphite agglomerate vs the f-NG raw material and PGPT102 commercial graphite. The study, presented in FIG. 24, shows that the charge rate capability of the graphite agglomerate is comparable to that of PGPT102, with slightly lower charge capacity but similar capacity retention from C/20 to 1C. A decrease of the charge capacity is only observed at 2C, but this decay is very limited (around 2%). More importantly, the performance of the agglomerate is superior to the raw material, as markedly higher capacities are displayed throughout the experiment.

TABLE 7
Figures of merit extracted from FIG. 7 to compare the electrochemical
performances of the different anodes

| | | | | | |
|---|---|---|---|---|---|
| | | | Coated- | Coated- | |
| | | | graphite | graphite | |
| | | Graphite | agglomerate | agglomerate | |
| Material | Raw f-NG | agglomerate | (1-step HT) | (2-step HT) | PGPT102 |

1^{st} Cycle

| | | | | | |
|---|---|---|---|---|---|
| Discharge | 421 | 400 | 401 | 410 | 388 |
| capacity (mAh · g⁻¹) | | | | | |
| Irreversible | 83 | 61 | 55 | 64 | 35 |
| capacity (mAh · g⁻¹) | | | | | |
| Coulombic | 80.3 | 84.7 | 86.2 | 84.5 | 91.1 |
| efficiency (%) | | | | | |

3^{rd} Cycle

| | | | | | |
|---|---|---|---|---|---|
| Discharge | 346 | 331 | 337 | 346 | 358 |
| capacity (mAh · g⁻¹) | | | | | |
| Cumulative | 102 | 68 | 64 | 72 | 40 |
| irreversible | | | | | |
| capacity (mAh · g⁻¹) | | | | | |
| Coulombic | 98.5 | 99.4 | 99.3 | 99.3 | 99.3 |
| efficiency (%) | | | | | |

100^{th} Cycle

| | | | | | |
|---|---|---|---|---|---|
| Discharge | N/A | 332 | 330 | 337 | 356 |
| capacity (mAh · g⁻¹) | | | | | |
| Cumulative | N/A | 140 | 100 | 131 | 97 |
| irreversible | | | | | |
| capacity (mAh · g⁻¹) | | | | | |
| Coulombic | N/A | 99.8 | 99.9 | 99.9 | 99.9 |
| efficiency (%) | | | | | |

### d) Post-Mortem Analysis

To further investigate the deterioration of the electrode with cycling, as well as the effect of the pitch coating, a post-mortem analysis was performed on the agglomerate-based electrodes at the end of the 200-cycle test and compared to electrodes before cycling.

FIGS. 9a, 9b, and 9c show the top view SEM images of graphite agglomerate, pitch-coated graphite agglomerate (1-step HT), and pitch-coated graphite agglomerate (2-step HT) electrodes, respectively, before cycling. Images (a′, b′ c′) show a top view of corresponding electrodes after 200 cycles, while (a″, b″, c″) feature corresponding cross-section images of cycled electrodes. Insets on top view images are high magnification visualizations of their corresponding electrodes. Although flattened due to the calendering process, agglomerate particles on the surface of non-cycled electrodes can be straightforward identified, as displayed in insets of FIGS. 9a, 9b, and 9c. However, after 200 cycles, the surface of the uncoated graphite agglomerate shows no clear boundaries between agglomerate particles (FIG. 9a′), due to the formation of the SEI layer and the swelling of said particles on the electrode. Moreover, higher magnification imaging (Inset of FIG. 9a′) revealed numerous cracks on the SEI layer, which developed due to volume changes of the graphite agglomerate particles upon intercalation. Similarly, no agglomerate particles can be distinguished in the cross-section image of the cycled electrode (FIG. 9a″), and instead, a densified structure with smooth regions is observed. In stark contrast, the cycled pitch-coated graphite (1-step HT and 2-step HT) agglomerate electrodes (FIGS. 9b′ and 9c′, respectively) retained the features exhibited in their non-cycled state. As shown in the insets of FIGS. 9b′ and 9c′, despite the SEI layer being present on the electrode surface, the agglomerate particles remained well defined after 200 cycles. Furthermore, no obvious deterioration of the SEI layer was observed. In similar fashion, the cross-section images of these electrodes (FIGS. 9b″ and 9c″) resemble that of their pristine state (FIGS. 6c and 6d). As the comparison of mass and thickness before and after cycling (measured in glovebox) reported in Table 8 shows, the electrodes made of pitch-coated graphite, particularly that obtained through 1-step HT, experienced considerably less thickness increase after 200 cycles (23%), in comparison with the uncoated graphite agglomerate electrode (36%). The pronounced differences between uncoated and pitch-coated graphite agglomerate electrodes after cycling confirm the efficacy of the pitch coating as a protective layer by restraining the volume expansion of graphite during lithium intercalation and to stabilize the SEI layer.

TABLE 8
Electrodes mass and thickness increase after 200 cycles

| | Mass | | | Thickness | | |
|---|---|---|---|---|---|---|
| | Initial | Final | Increase | Initial | Final | Increase |
| Electrode | (mg) | (mg) | (%) | (μm) | (μm) | (%) |
| Graphite agglomerate | 4.70 | 5.83 | 24 | 45 | 61 | 36 |
| Pitch-coated graphite | 4.56 | 5.60 | 23 | 44 | 54 | 23 |
| agglomerate (1-step HT) | | | | | | |
| Pitch-coated graphite | 4.63 | 5.71 | 23 | 45 | 60 | 33 |
| agglomerate (2-step HT) | | | | | | |

It was demonstrated that by-product graphite fines from spheroidization of flake natural graphite can be recycled and valorized using relatively simple and inexpensive methods, such as spray drying and heat treatment, which allowed the successful re-agglomeration of fine graphite into graphite agglomerate particles. The preliminary spray drying study allowed to fine-tune the slurry composition and spray drying parameters to obtain nearly spherical spray-dried re-agglomerated graphite particles and graphite agglomerate particles with D50 comparable to a commercial battery grade natural graphite. The resulting agglomerate exhibited sufficient mechanical strength to endure the calendering process, which is a standard step in the manufacture of anode for LIBs. Despite having a relatively large surface area due to the carbonization of the binder, the graphite agglomerate particles yield higher initial Coulombic efficiency with respect to the raw material, and it exhibited cycling performances comparable to a commercial natural graphite for over 100 cycles. The surface modification of the agglomerate by pitch coating further improved the electrochemical and mechanical properties of the material, reflected especially in the cumulative irreversible capacity and post-mortem SEM images after 200 cycles. The favorable effect of pitch coating was more evident in the material obtained through 1 heat treatment step. The reasons behind the different properties for pitch-coated agglomerate materials obtained in 1 and 2 heat treatment steps remain to be investigated. Overall, the proposed strategy has the potential for successful recycling and re-integration of by-product graphite into the production chain anodes for LIBs, which could lead to increased productivity and financial gains for battery grade natural graphite producers.

### Example 3: Graphite Agglomerate Particles with CNTs—Experimental Conditions and Methods

### a) Reagents

Fine natural graphite (f-NG) (carbon content=99.7%, D₅₀≈7 μm) obtained as by-product of the spheroidization of purified natural graphite flakes was used without further purification. The petroleum pitch (ZL 250 M) (RÜTGERS Germany GmbH) was used without further purification. Sodium carboxymethyl cellulose (average molecular weight M_{W}≈90,000; degree of substitutions=0.7), lithium foil (thickness 1 mm; 99.9%), and battery grade LP30 (a LiPF₆ solution in EC and DMC with a concentration of 1 M of LiPF₆ in EC/DMC (50/50; v/v) were purchased from Sigma. Citric acid (>99.5%) was purchased from Alfa Aesar. SBR (50% solid content) and Super C65 conductive carbon black were purchased from MTI corporation. PGPT102 natural graphite (battery grade) was purchased from Targray. SWCNTs dispersion (TUBALL™ BATT H₂O; 0.4% CNTs; 0.6% CMC; 99% H₂O) was purchased from OCSiAl.

b) Preparation of Graphite Agglomerate Particles with CNTs by Spray Drying

The method for graphite fines re-agglomeration was carried out by the same method as described in Example 1(b). The addition of CNTs in the graphite agglomerate particles was achieved by adding a commercial CNTs dispersion directly in the feedstock for spray drying. Considering the composition of the CNTs dispersion, a slurry was designed to obtain agglomerate particles with about 1 wt. % CNTs content.

The slurry for spray drying comprised 78 wt. % of deionized water, 2 wt. % of CMC, 19.8 wt. % of graphite fines, and 0.2 wt. % of CNTs. The composition of the spray-dried powder was therefore 90 wt. % graphite fines, 0.91 wt. % CNTs, and 9.09 wt. % CMC.

### c) Heat Treatment

The spray-dried powder was subjected to heat treatment in a tube furnace (Thermo Scientific™; Thermolyne™ F21125) under an inert Ar (99.998%) flow for binder carbonization. The heat treatment profile comprises ramp heating from room temperature to about 1100° C. (2.00° C./min ramp), isothermal heating at about 1100° C. for about 2 hours, and naturally cooled to room temperature. The mass loss due to carbonization during heat treatment was about 8.8%. Assuming that only the CMC undergoes thermal decomposition, the composition of the resulting powder is approximately 98.7 wt. % graphite, 1.0 wt % CNTs, 0.3 wt. % amorphous carbon from the decomposition of CMC.

d) Alternative Heat Treatment to Produce Pitch-Coated Graphite Agglomerate Particles with CNTs

Alternatively, to obtain pitch-coated graphite agglomerate particles with CNTs, the spray-dried powder described above was mixed with coal tar pitch in a 9:1 (graphite agglomerate particles with CNTs:coal tar pitch) mass ratio and subjected to the same heat treatment as described in Example 3d. Since the mixture underwent a single heat treatment for thermal decomposition of both the coal tar pitch and the CMC binder, the total mass loss after heat treatment was about 11.6%. As a result, the composition of the obtained powder is about 91.6 wt. % graphite, 0.9 wt. % CNTs, 7.4 wt. % amorphous carbon.

### Example 4: Graphite Agglomerate Particles with CNTs—Characterization

### a) Physicochemical Characterization

FIG. 26 shows top-view SEM images of a graphite agglomerate particle with CNTs, while FIG. 27 shows cross-sectional SEM images of the same material. The CNTs can be observed on the surface of the particle, as well as inside the agglomerate.

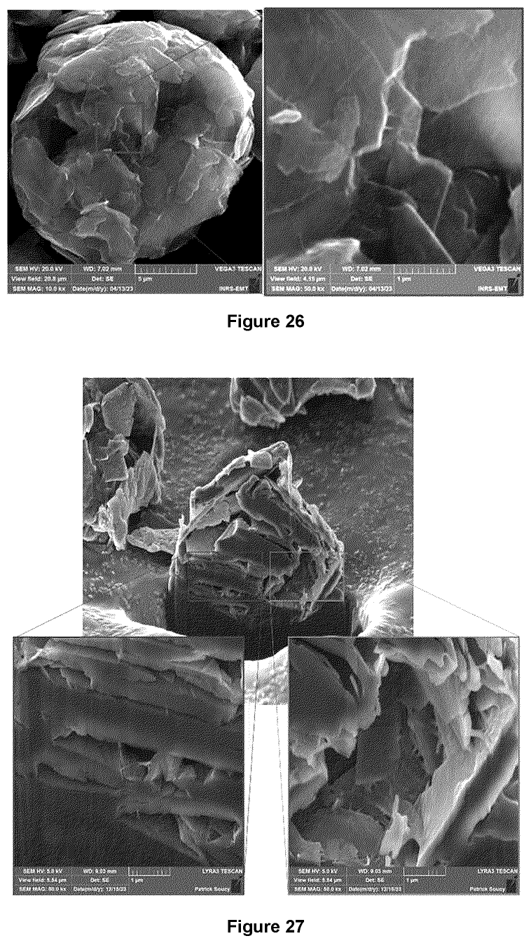

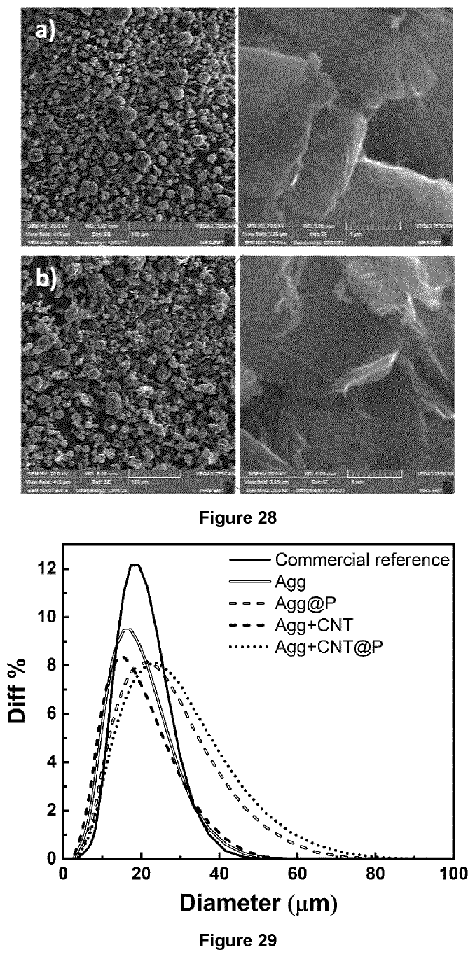

FIG. 28 shows SEM images in a) of uncoated graphite agglomerate particles with CNTs, and in b) of pitch-coated graphite agglomerate particles with CNTs. FIG. 28 demonstrates that the addition of pitch does not significantly change the aspect of the surface of the particle due to the thin nature of the pitch coating, and thus, the CNTs are still visible.

FIG. 29 is a graph showing the PSD for conventional PGPT102, graphite agglomerate particles, pitch-coated graphite agglomerate particles, graphite agglomerate particles with CNTs, and pitch-coated graphite agglomerate particles with CNTs.

### b) Electrochemical Performances

Electrodes comprising graphite agglomerate particles with CNTs as the active material were prepared by the method described in Example 1(h). Swagelok® type cells comprising these electrodes were assembled using the protocol described in Example 1(h). These cells were the cycled using the protocol described in Example 1(i).

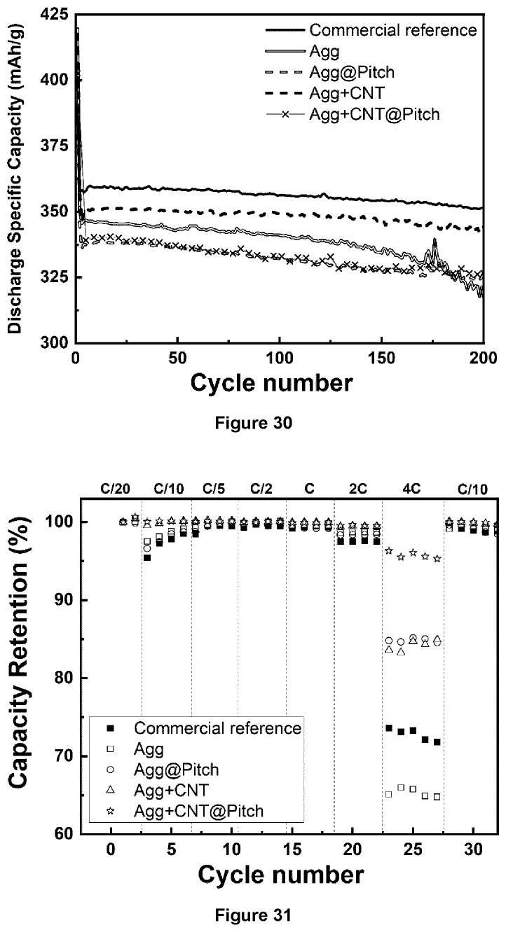

FIG. 30 shows a graph of the discharge specific capacity as a function of the cycle number. Results are shown for conventional PGPT102, graphite agglomerate particles, pitch-coated graphite agglomerate particles, graphite agglomerate particles with CNTs, and pitch-coated graphite agglomerate particles with CNTs. FIG. 30 shows that the addition of CNTs significantly improved the cycling stability of the graphite agglomerate particles.

FIG. 31 shows a graph of the delithiation rate capability performances. Results are shown for conventional PGPT102, graphite agglomerate particles, pitch-coated graphite agglomerate particles, graphite agglomerate particles with CNTs, and pitch-coated graphite agglomerate particles with CNTs. The rate rate capability tests (FIG. 31) show that a significant improvement was observed upon addition of CNTs, particularly at 4C (84% capacity retention vs 64% for graphite only). Moreover, the pitch-coated graphite agglomerate particles with CNTs showed the best performances at 4C, as the capacity retention reached 95%.

### Example 5: Graphite Silicon Composite Agglomerate Particles with and without CNTs—Experimental Conditions and Methods

### a) Reagents

Fine natural graphite (f-NG) (carbon content=99.7%, D₅₀≈7 μm) obtained as by-product of the spheroidization of purified natural graphite flakes was used without further purification. The petroleum pitch (ZL 250 M) (RUTGERS Germany GmbH) was used without further purification. Sodium carboxymethyl cellulose (average molecular weight M_{W}≈90,000; degree of substitutions=0.7), potassium hydroxide (KOH) (85%), lithium foil (thickness 1 mm; 99.9%), battery grade LP30 (a LiPF₆ solution in EC and DMC with a concentration of 1 M of LiPF₆ in EC/DMC (50/50; v/v), and fluoroethylene carbonate (FEC) (99%) were purchased from Sigma. Citric acid (>99.5%) was purchased from Alfa Aesar. SBR (50% solid content) and Super C65 conductive carbon black were purchased from MTI corporation. PGPT102 natural graphite (battery grade) was purchased from Targray. Micro silicon powder (APS 1-5 microns; 99.9% (metal basis)) was purchased from Alfa Aesar, while nano-Si powder (APS 50 nm; >9 7%) was purchased from Trunnano. SWCNTs dispersion (TUBALL™ BATT H₂O; 0.4% CNTs; 0.6% CMC; 99% H₂O) was purchased from OCSiAl.

### b) Preparation of Graphite Silicon Composite Agglomerate Particles by Spray Drying

Agglomeration of graphite fines and silicon was achieved by spray drying (Pilotech, Mini Spray Dryer YC-015) by a method similar as the one described in Example 1(b). The graphite content in the composition was adjusted to account for the incorporation of silicon powder in the mixture. The feedstock for spray drying was a slurry comprising 72 wt. % of water, 4 wt. % of CMC, and 24 wt. % of graphite fines. The latter comprised select mass ratios of graphite fines and silicon (micro and nano) powder (100:0, 95:5, 91:9, and 85:15) which further served to evaluate the effect of the silicon size and nano-silicon content on the cycle life of the materials.

c) Preparation of Spherical Graphite Silicon Composite Agglomerate Particles with CNTs

The inclusion of 1 wt. % CNTs in the graphite silicon composite agglomerate particles was performed via spray drying. Similarly, the slurry was designed considering the composition of the CNTs dispersion to obtain composite agglomerate particles with a content of 15 wt. % nano-silicon and 1 wt. % CNTs.

A slurry comprising 78.0 wt. % of water, 2.0 wt. % of CMC, 16.8 wt. % of graphite fines, 3.0 wt. % of nano-silicon powder, and 0.2 wt. % of CNTs was spray-dried for the synthesis of spherical graphite silicon composite agglomerate particles with CNTs. The composition of the spray-dried powder was therefore 76.5 wt. % of graphite fines, 13.6 wt. % of nano-silicon, 0.9 wt. % of CNTs, and 9.0 wt. % of CMC.

All the slurries were mixed by resonant acoustic mixer at an acceleration of about 50 G for about 30 minutes. Feed rate, inlet temperature, and air blow rate spray drying parameters were set to about 20.3 mL·min⁻¹, about 210° C., and about 2.5 m³·min⁻¹, respectively.

### 2.4. Heat Treatment

Spray-dried powders were subjected to heat treatment in a tube furnace (Thermo Scientific™; Thermolyne™ F21125) under an inert Ar (99.998%) flow for binder carbonization. The heat treatment profile comprises ramp heating from room temperature to about 1100° C. (2.00° C./min ramp), isothermal heating at about 1100° C. for about 2 hours, and naturally cooled to room temperature.

Assuming that only the CMC undergoes thermal decomposition, the mass loss due to binder carbonization during heat treatment for the CNTs-free materials was about 11.5%, which accounts for about 80.5% of CMC. As a result, the heat-treated powders contain about 3.1 wt. % of residual carbon and have a graphite content of 92.1 wt. %, 88.1 wt. %, and 82.3 wt. %, with corresponding silicon content of 4.8 wt. %, 8.8 wt. %, and 14.6 wt. %, hereafter referred as G95Si5, G91Si9, and G85Si15, respectively.

Similarly, the mass loss for the graphite silicon composite agglomerate particles with CNTs was about 9.7%, which accounts for about 87.7% of the CMC, resulting in a powder composition of 82.7 wt. % of graphite, 14.8 wt. % of silicon, and 1 wt. % of CNTs.

The heat-treated powders were sieved with an ultrasonic sieve (GilSonic AutoSiever™ Sonic Sifter; GA-6) using a stainless-steel mesh with 45 μm openings. The fraction of eliminated particles was under 10 wt. %.

### Example 6: Graphite Silicon Composite Agglomerate Particles without CNTs—Characterization

### a) Physicochemical Characterization

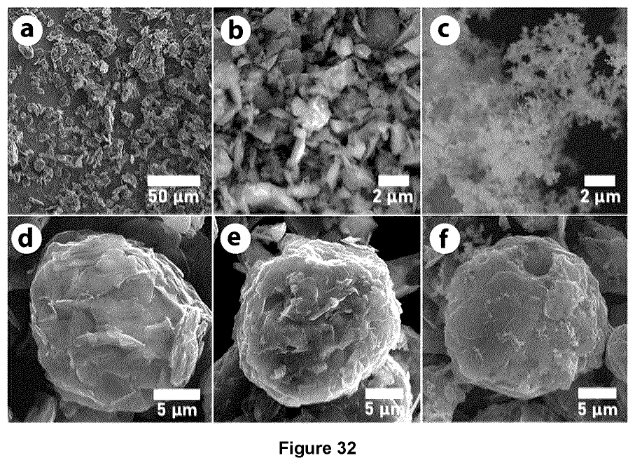

FIG. 32 shows SEM images in a) of raw graphite fines, in b) of micro silicon powder, in c) of nano-silicon powder, in d) of a graphite agglomerate particle, in e) of a graphite silicon composite agglomerate particle (9 wt. % micro silicon), and in f) of a graphite silicon composite agglomerate particle (9 wt. % nano-silicon).

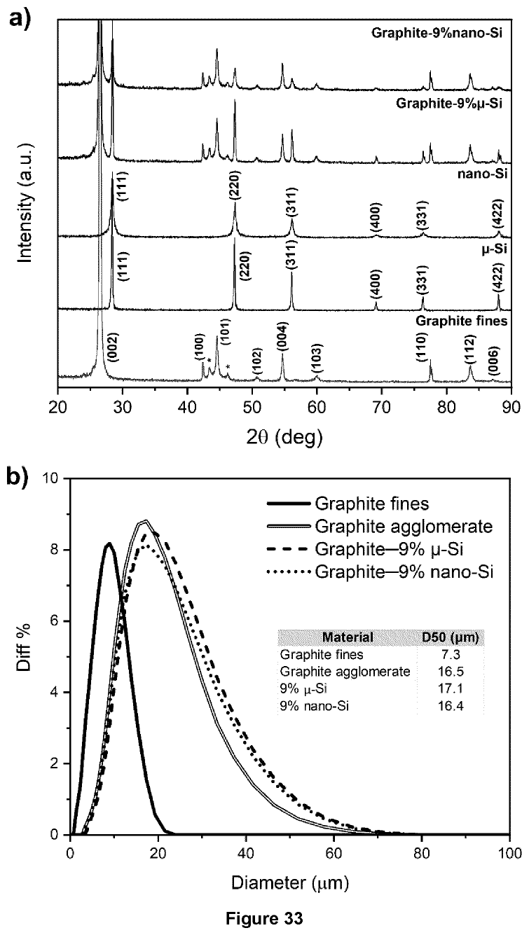

FIG. 33 shows in a) XRD patterns, and in b) a graph showing the PSD for raw graphite fines, micro silicon powder, nano-silicon powder, graphite agglomerate particles, graphite silicon composite agglomerate particles (9 wt. % micro silicon), and graphite silicon composite agglomerate particles (9 wt. % nano silicon).

### b) Electrochemical Performances

Electrodes comprising graphite silicon composite agglomerate particles without CNTs as the active material were prepared by the method described in Example 1(h). Swagelok® type cells comprising these electrodes were assembled using the protocol described in Example 1(h). These cells were the cycled using the protocol described in Example 1(i).

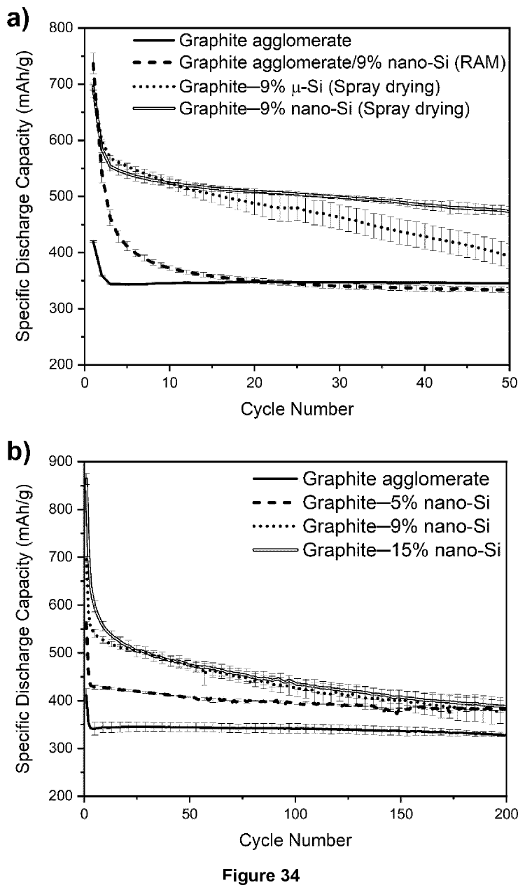

FIG. 34 shows in a) the short-term cycling performances of the composites obtained by spray drying and a mixture of graphite fines and nano-silicon powders obtained by resonant acoustic mixer. The rapid capacity drop of the latter demonstrates that the silicon nanoparticles were not embedded in the graphite agglomerate, which validates the effectiveness of the spray drying technique to integrate silicon powder in the graphite agglomerate, as shown in FIG. 32. The considerable capacity decay over 50 cycles observed in the composite with micro silicon may be attributed to its significant volume expansion, which contrasts with the moderate expansion of nano-silicon, a well-known phenomenon that results in improved cycling stability.

FIG. 34 shows in b) the effect of different nano-silicon content in the graphite agglomerate. 5 wt. % of nano-silicon increased the capacity compared with pure graphite by about 23% with a relatively good stability over 200 cycles, as less than 10% capacity was lost. However, while 9 wt. % of nano-silicon increased the specific capacity by more than 60%, most of it was lost at the end of 200 cycles. Moreover, 15 wt. % of nano-silicon did not significantly improve specific capacity nor capacity retention. The results indicate that the nano-silicon expansion becomes significant at 9 wt. % and 15 wt. % content. For this reason, the addition of CNTs was evaluated as a mean to stabilize the expansion of nano-silicon, preserve the structural integrity, and/or maintain the electronic conductivity of the composite particles.

### Example 7: Graphite Silicon Composite Agglomerate Particles with CNTs—Characterization

### a) Physicochemical Characterization

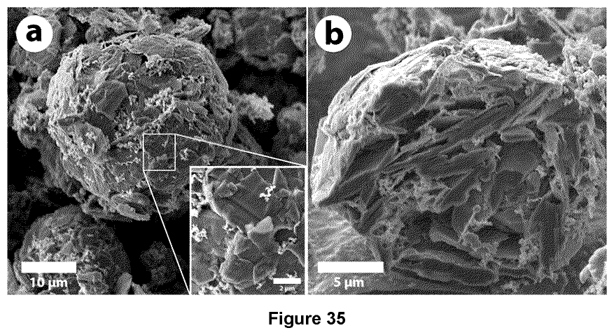

FIG. 35 shows in a) a SEM image of graphite silicon composite agglomerate particles with CNTs, and in b) a cross-section of a single graphite silicon composite agglomerate particle with CNTs. The CNTs can be observed on the surface of the particles (inset FIG. 35 a). The cross-section image allows observing nano-silicon aggregates inside the agglomerate composite particle. While CNTs are not observed at this magnification, it was demonstrated in Example 4(a) (FIG. 27) that CNTs are also found inside the agglomerate particle.

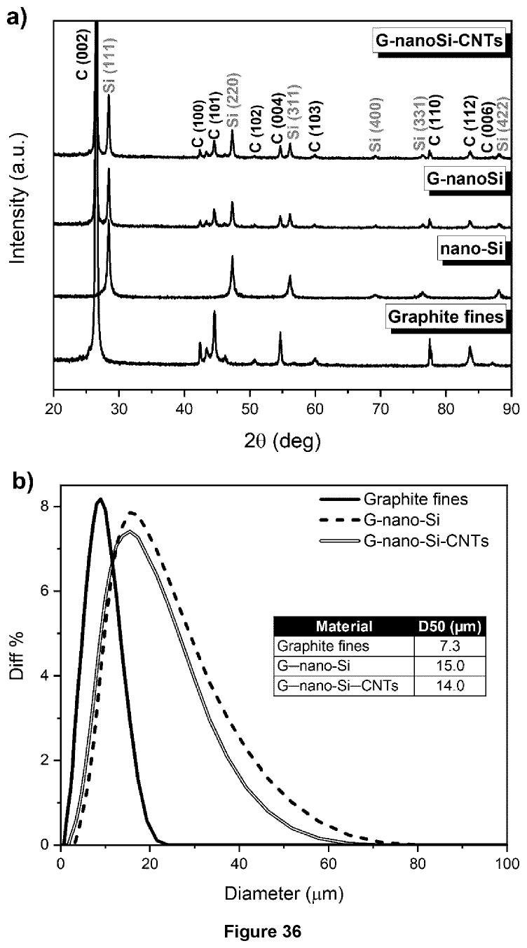

FIG. 36 shows in a) XRD patterns for raw graphite fines, graphite nano-silicon composite agglomerate particles without CNTs, nano-silicon powder, and graphite nano-silicon composite agglomerate particles with CNTs, and in b) a graph showing the PSD for raw graphite fines, graphite nano-silicon composite agglomerate particles without CNTs (graphite:nano-silicon mass ratio (85:15)), and graphite nano-silicon composite agglomerate particles with CNTs (graphite:nano-silicon:CNTs mass ratio (84:15:1)).

### b) Electrochemical Performances

Electrodes comprising graphite silicon composite agglomerate particles with and without CNTs as the active material were prepared by the method described in Example 1(h). Swagelok® type cells comprising these electrodes were assembled using the protocol described in Example 1(h). These cells were the cycled using the protocol described in Example 1(i).

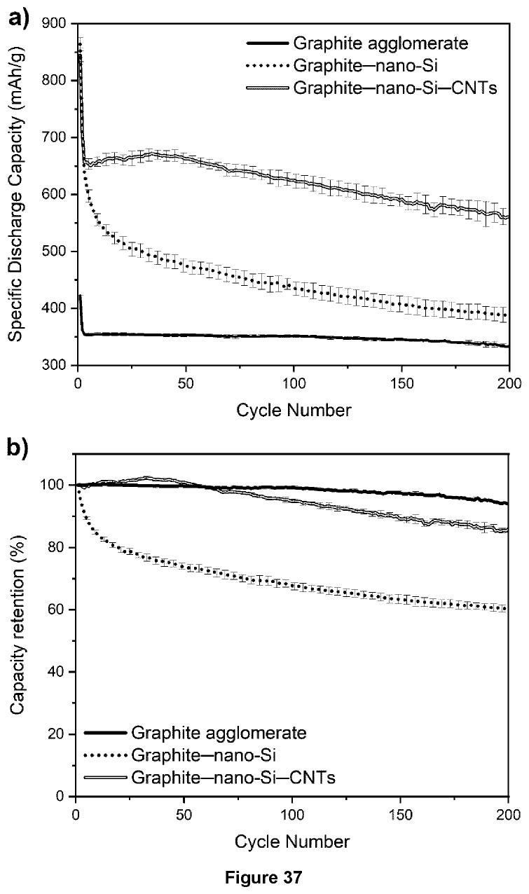

FIG. 37 shows in a) a graph of the discharge specific capacity as a function of the cycle number, and in b) a graph of the capacity retention as a function of the cycle number for graphite agglomerate particles, graphite nano-silicon composite agglomerate particles without CNTs, and graphite nano-silicon composite agglomerate particles with CNTs.

More particularly, this figure compares the cycling performance of the graphite nano-silicon composite agglomerate particles with and without CNTs. Cycling of only graphite agglomerate particles is shown for reference. The tests show that the CNTs can delay and/or slow down the capacity decay of the graphite nano-silicon composite agglomerate particles, resulting in a capacity retention of about 95% after 200 cycles, while that of the CNTs-free composite dropped to 60% (FIG. 37 b).

Numerous modifications could be made to any of the embodiments described above without departing from the scope of the present invention as contemplated. References, patents, or scientific literature referred to herein are incorporated herein by reference in their entirety and for all purposes.

1. A method for producing graphite agglomerate particles, the method comprising the steps of:
i) providing a graphite fines slurry comprising a plurality of graphite fines, a solvent, and a binder;
ii) spray drying the graphite fines slurry to for spray-dried re-agglomerated graphite particles; and
iii) heat treating the spray-dried re-agglomerated graphite particles to obtain the graphite agglomerate particles.

2. The method of claim 1, wherein the binder comprises a polymer binder selected from the group consisting of carboxymethyl cellulose, polyvinyl alcohol, polyethylene glycol, polyacrylic acid, polyvinylpyrrolidone, polylactic acid, cellulose, chitin, starch, polycaprolactone, polyhydroxy butyrate, and a combination of at least two thereof, and preferably the polymer binder is carboxymethyl cellulose.

3.-4. (canceled)

5. The method of claim 1, wherein the solvent is selected from the group consisting of water, methanol, acetone, ethanol, dichloromethane, tetrahydrofuran, ethyl acetate, chloroform, glycerin, dimethylformamide, dimethyl sulfoxide, and a miscible combination of at least two thereof, and preferably the solvent is water.

6. (canceled)

7. The method of claim 1, wherein a mass ratio of graphite fines to binder in the graphite fines slurry is between about 4:1 and about 20:1, upper and lower limits included, and preferably the mass ratio of graphite fines to binder in the graphite fines slurry is about 6:1.

8.-10. (canceled)

11. The method of claim 1, wherein the graphite fines slurry;
comprises between about 14 wt. % and about 35 wt. % of graphite fines, upper and lower limits included, and preferably the graphite fines slurry comprises about 24 wt. % of graphite fines; and/or
comprises between about 0.7 wt. % and about 6.0 wt. % of the binder, upper and lower limits included, and preferably the graphite fines slurry comprises about 4.0 wt. % of the binder; and/or
comprises between about 58 wt. % and about 83 wt. % of the solvent, upper and lower limits included, and preferably the graphite fines slurry comprises about 69 wt. % of the solvent.

12.-14. (canceled)

15. The method of claim 1, wherein the graphite fines in the graphite fines slurry have been purified, or wherein the purity of the graphite fines is between about 99.70% and about 99.99%, upper and lower limits included, and preferably the purity of the graphite fines is about 99.95%.

16.-19. (canceled)

20. The method of claim 1, wherein the D₅₀ of graphite fines is between about 3 μm and about 10 μm, upper and lower limits included,
and preferably the D₅₀ of the graphite fines is about 7 μm.

21.-27. (canceled)

28. The method of claim 1, wherein the graphite fines slurry further comprises a cross-linking agent, wherein:
the cross-linking agent is preferably selected from the group consisting of citric acid, formic acid, acetic acid, oxalic acid, and a combination of at least two thereof, and more preferably the cross-linking agent is citric acid; and/or
the graphite fines slurry preferably comprises between about 0.5 wt. % and about 4.0 wt. % of the cross-linking agent, upper and lower limits included, and more preferably the graphite fines slurry comprises about 3.0 wt. % of the cross-linking agent; and/or
the graphite fines slurry preferably comprises about 24 wt. % of graphite fines, about 4.0 wt. % of the binder, about 3.0 wt. % of the cross-linking agent, and about 69 wt. % of the solvent.

29.-41. (canceled)

42. The method of claim 1, wherein providing the graphite fines slurry comprises preparing the graphite fines slurry preferably by combining the graphite fines, the binder, optionally the cross-linking agent, and the solvent, and then mixing the components together, and preferably the graphite fines slurry is mixed by resonant acoustic mixer preferably at an acceleration of 50 G for about 30 minutes.

43.-45. (canceled)

46. The method of claim 1, wherein the graphite fines slurry further comprises silicon particles, wherein the D₅₀ of the silicon particles in the graphite fines slurry is preferably between about 50 nm and about 5 μm, upper and lower limits included.

47.-48. (canceled)

49. The method of claim 1, wherein the graphite fines slurry further comprises an additive selected from carbon black, graphite, graphene, carbon fibers, carbon nanotubes, and a combination of at least two thereof, preferably the additive is carbon nanotubes, wherein the graphite fines slurry preferably comprises between about 0.1 wt. % and about 3 wt. % of carbon nanotubes, upper and lower limits included.

50.-52. (canceled)

53. The method of claim 1, wherein:
a feed rate of the spray drying is between about 10 mL·min⁻¹ and about 22 mL·min⁻¹, upper and lower limits included, and preferably the feed rate of the spray drying is about 20.3 mL·min⁻¹; and/or
an inlet temperature during the spray drying step is between about 190° C. and about 220° C., upper and lower limits included, and preferably the inlet temperature during the spray drying step is about 210° C.; and/or
an air blow rate during the spray drying step is between about 2.0 m³·min⁻¹ and about 2.5 m³·min⁻¹, upper and lower limits included.

54.-61. (canceled)

62. The method of claim 1, wherein the spray-dried re-agglomerated graphite particles are heat treated in the presence of a carbon precursor to obtain carbon-coated graphite agglomerate particles, wherein the carbon precursor is preferably selected from petroleum pitch, coal tar pitch, biomass pitch, a combination of at least two thereof, and any similar material, and more preferably the carbon precursor is coal tar pitch.

63.-64. (canceled)

65. The method of claim 1, wherein the heat treatment step comprises heating the spray-dried re-agglomerated graphite particles at a temperature between about 550° C. and about 1300° C., upper and lower limits included, and preferably the spray-dried re-agglomerated graphite particles are heated at a temperature of about 1000° C.

66.-68. (canceled)

69. The method of claim 1, wherein the spray-dried re-agglomerated graphite particles formed in step (ii) are mixed with a carbon precursor followed by a heat treatment step for the thermal decomposition of the carbon precursor, wherein:
the carbon precursor is preferably coal tar pitch; and/or
the spray-dried re-agglomerated graphite particles:carbon precursor mass ratio is preferably about 9:1; and/or
the mixing step is performed by resonant acoustic mixer preferably at an acceleration of 50 G for about 15 minutes; and/or
the spray-dried re-agglomerated graphite particles and the carbon precursor are mixed together using wet mixing or dry mixing; and/or
the amount of carbon precursor in a mixture comprising the spray-dried re-agglomerated graphite particles and the carbon precursor is between about 5 wt. % and about 30 wt. %, upper and lower limits included, and more preferably the amount of carbon precursor in the mixture is about 10 wt. %; and/or
the thermal decomposition of the carbon precursor and of the binder are performed in a single step heat treatment, preferably wherein the heat
treatment is performed as two sub-steps, wherein spray-dried re-agglomerated graphite particles are first heat treated to form graphite agglomerate particles, and then said graphite agglomerate particles are mixed with the carbon precursor, followed by a second heat treatment for carbon coating.

70.-80. (canceled)

81. The method of claim 1, wherein the heat treatment further comprises subjecting the spray-dried re-agglomerated graphite particles to a high temperature heat treatment performed at a temperature between about 2000° C. and about 3000° C., upper and lower limits included.

82. Graphite agglomerate particles produced using the method as defined in claim 1.

83. The graphite agglomerate particles of claim 82, wherein:
the graphite agglomerate particles are spherical-shaped particles or near-spherical-shaped particles; and/or
the D₅₀ of said graphite agglomerate particles is between about 18 μm and about 21 μm, or between about 20 μm and about 24 μm, or between about 13 μm and about 17 μm, upper and lower limits included; and/or
the graphite agglomerate particles are carbon-coated graphite agglomerate particles; and/or
the graphite agglomerate particles are pitch-coated graphite agglomerate particles; and/or
the graphite agglomerate particles further comprise silicon, preferably wherein the graphite agglomerate particles comprise a silicon content of at least about 3 wt. % and at most about 50 wt. %.

84.-92. (canceled)

93. An electrode material comprising graphite agglomerate particles as defined in claim 82.

94.-100. (canceled)

101. An electrode comprising the electrode material as defined in claim 93 applied on a current collector.

102.-105. (canceled)

106. An electrochemical cell comprising an anode, a cathode,
and an electrolyte, wherein at least one of the anode and the cathode is the electrode as defined in claim 101.

107. An electrochemical accumulator comprising at least one electrochemical cell as defined in claim 106.

108.-110. (canceled)
